(19) United States
(12) Patent Application Publication
(10) Pub. No.: US 2013/0036034 A1
(43) Pub. Date: Feb. 7, 2013

(54) Method and System for Distributed Network Accounting

(71) Applicants: Jonathan Karon, Portland, OR (US); William Spazante, Pacific Grove, CA (US)

(72) Inventors: Jonathan Karon, Portland, OR (US); William Spazante, Pacific Grove, CA (US)

(73) Assignee: SOCIAL FINANCIAL, INC.

(21) Appl. No.: 13/491,826

(22) Filed: Jun. 8, 2012

Related U.S. Application Data
(60) Provisional application No. 61/495,222, filed on Jun. 9, 2011.

(51) Int. Cl. G06Q 20/40; G06Q 40/00

(52) U.S. Cl. 705/31; 705/39; 705/44

(57) ABSTRACT

This disclosure relates to a method and system for storing beneficiary allocation preferences and processing financial transactions across a multiplicity of independent media publishers and socially responsible advocates operating over a distributed computer network wherein subscribers elect varying levels of support for geographically diverse beneficiaries having dissimilar accounting, accrual, legal and organizational structures, and wherein proceeds from subscriber-initiated financial transactions are allocated among the beneficiaries according to subscriber preference.

### CROSS-REFERENCE TO RELATED APPLICATION

This application claims the benefit of U.S. Provisional Patent Application Ser. No. 61/495,222 entitled “METHOD AND SYSTEM FOR DISTRIBUTED NETWORK ACCOUNTING,” filed on Jun. 9, 2011, which is herein entirely incorporated by reference.

### FIELD

This disclosure relates to the field of distributed computer systems and more specifically to a method and system for storing relative allocation preferences amongst distinct organizations of different types such as municipal, charitable, and political by each user of the system, and processing financial and/or e-commerce transactions such that proceeds and/or dividends associated with individual transactions are dynamically allocated according to the stored allocation preferences of each user who initiates the transaction. The disclosed embodiments provide a method and system for processing financial transactions wherein each media publisher or advocate responsible for inducing a user to initiate a financial transaction or support a specific organization for allocation is rewarded for such inducement in proportion to the value of the financial transaction and/or payment to the organization, as appropriate.

### BACKGROUND

Internet-based communication has become increasingly important to organizations of all types. Recently those organizations dependent on popular support for programs and financing have turned increasingly to Internet-based communications to spread their message and recruit support. This interest has led to the proliferation of web sites and web-based software applications intended to support organizations' efforts in this regard. Further, the need to support financial transactions initiated by these online communications has led each organization and each software provider to implement one or more systems for revenue generation, whether through credit card and bank transaction processing or via e-commerce and associated affiliate networks.

This proliferation has resulted in individual web sites and software providers competing with one another for the attention of individual supporters and revenue opportunities associated therewith. The direct payment model of revenue generation forces each organization or software provider to maintain an ongoing relationship with the individual supporter and motivate them to return to the same web site or service every time the individual wants to support an organization or make an e-commerce transaction. The accelerating competition via email, online and direct mail marketing, and emerging social media services has led to so-called supporter burn-out, where individuals inclined to support one or more organizations are bombarded by so many solicitations that they cease to support any. Similarly, each organization and software provider must implement financial transaction systems and accounting, receipt, and government-imposed compliance processes that are costly to develop and maintain.

The embodiments presented herein provide a novel method and system for consolidating the tracking, transaction processing, accounting and compliance requirements of various organizations while also rewarding the organization, media publisher, advocate, or software provider responsible for motivating individuals to support specific organizations and to contribute financial support to the organizations.

### SUMMARY

In one embodiment, a system is provided for storing the relative allocation preferences amongst a number of beneficiary organizations for each subscriber to the system and processing financial transactions with merchants and/or financial institutions initiated by each of the subscribers such that a portion of the proceeds from each transaction are allocated to beneficiary organizations according to the relative allocation preferences of the initiating subscriber. The embodiments further allocate a portion of the proceeds from each transaction to each independent entity responsible for inducing the initiating subscriber to elect to support one or more beneficiaries and/or inducing the initiating subscriber to execute the financial transaction.

An authoritative organization data system maintains connections to one or more databases of beneficiary organizations (so-called “causes”) and coordinates distributed access to profile data and metadata of the organizations. A user authentication system authenticates each respective subscriber and a basket API system maintains each subscriber's current and historical elections to support various organizations exposed by the cause data system. A network authentication system authenticates computer systems acting as Internet publishers and provides granular access control to various data services exposed by the system. A publisher API system provides independent Internet systems, media publishers, and advocates with access to the system.

An accounting services system tracks the transfer of funds from each subscriber-initiated action, correlates each the transfer to basket system data, and allocates a portion of each of the transferred funds to any number of publishers and beneficiary organizations according to system-defined rules operating on subscriber preferences both current and historical. The accounting services system further aggregates financial transactions to optimize transaction costs and reporting burden while maintaining government and subscriber-mandated accounting data.

### BRIEF DESCRIPTION OF THE DRAWINGS

FIG. 1 is a cross-functional flow diagram illustrating the functioning of one embodiment of a system.

FIGS. 2A-2F are example aspects of user interfaces presented to users of the system, illustrating the interactions disclosed in FIG. 1.

FIG. 3 is a diagram of the architecture of one embodiment of a distributed network accounting system.

FIG. 4 is a diagram showing one embodiment of architectural hierarchy of subsystems managed by one embodiment of the distributed network accounting system server described in conjunction with FIG. 3.

FIGS. 5A-5E show one aspect of a data schema used in the operation of one embodiment of the distributed network accounting system described in conjunction with FIG. 3.

FIG. 6 is a cascading functional flow block diagram showing the basic operation of one embodiment of the distributed network accounting system of FIG. 3

FIG. 7 is a system flow diagram showing one aspect of a process wherein a media publisher or advocate creates a trackable link correlating the publisher or advocate with a certain cause.

FIG. 8 is a system flow diagram showing one aspect of a process whereby an Internet-connected computer creates a trackable link correlating the computer's operator with a certain cause.

FIG. 9 is a system flow diagram showing one aspect of a process whereby an Internet-connected computer requests the canonical URL for an identified beneficiary organization.

FIG. 10 is one aspect of a system flow diagram showing one embodiment of a distributed network accounting system tracking an initiation of an action by a subscriber with respect to an identified beneficiary organization.

FIG. 11 is a system flow diagram showing one aspect of a web site presenting a subscriber with a user interface incorporating the beneficiary organizations the subscriber has elected to support within his or her basket.

FIG. 12 is one embodiment of a system flow diagram showing a subscriber electing to support a designated beneficiary organization.

FIG. 13 is a system flow diagram showing one aspect of an Internet-connected system acting on behalf of a subscriber to add a designated cause to the subscriber's basket.

FIG. 14 is a system flow diagram showing one aspect of a subscriber electing to support one or more beneficiary organizations through the proceeds of an e-commerce transaction.

FIG. 15 is a system flow diagram showing one aspect of a subscriber electing to support one or more beneficiary organizations through a funds transfer via credit card, ACH transaction, etc.

FIG. 16 is a system flow diagram showing one aspect of a subscriber electing to adjust the relative allocation of funds to each of their supported beneficiary organizations and optionally distributing accrued funds according to the allocations.

FIG. 17 is a system flow diagram showing one embodiment of an accounting services system allocating accrued funds according to originating publishers and/or activists, subscriber preferences, and system-defined allocation rules.

### DETAILED DESCRIPTION

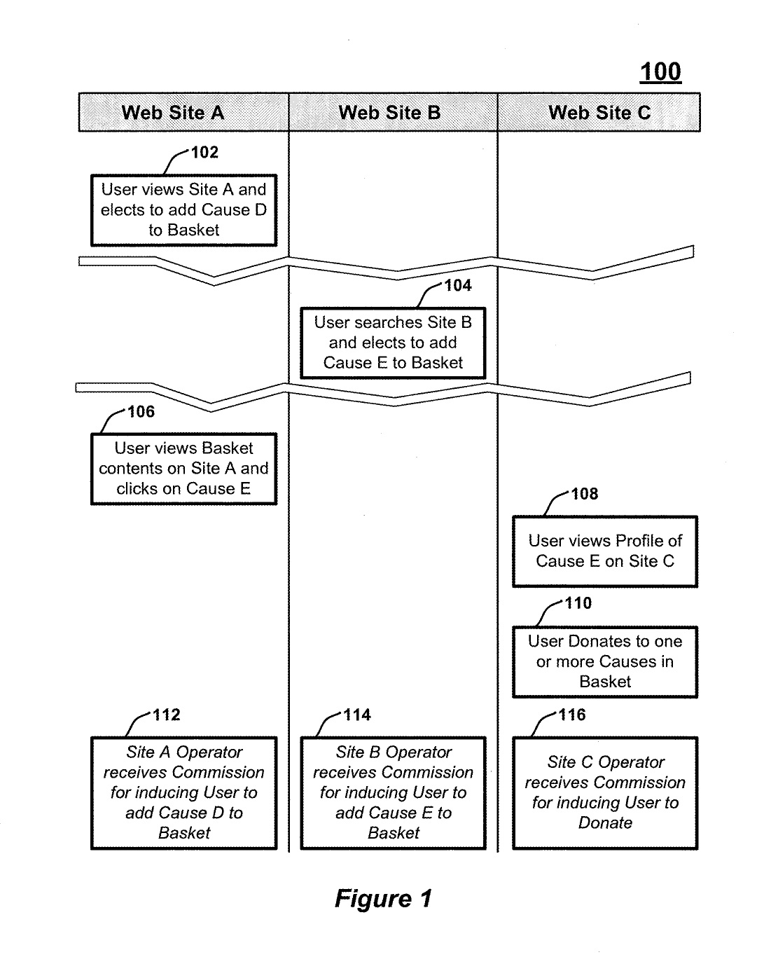

FIG. 1 is a cross functional flowchart presenting representative actions taken by a subscribing user on multiple web sites, each of which is an authorized affiliate of one embodiment of a distributed network accounting system, and detailing payments allocated by the system to the operators of the web sites when the user executes a financial transaction. A user interacts with an authorized affiliate web site A in process step 102. The web site presents, by way of example, profile information about at least one organization that visitors to the web site may wish to support. When the user elects to support organization D, the distributed network accounting system determines whether the user has previously elected to support the selected organization and, if not, creates an association record containing the organization D, the user, and affiliate web site A from which the election was initiated.

In an alternate implementation, the distributed network accounting system creates an association record even if the user has previously elected to support the identified organization, and future processing of the user's activities may account for both the existence of multiple association records and the sequence and metadata associated with the records' creation.

It should be noted that while this disclosure uses the terms organization and financial support, the envisioned system may incorporate any number of distinct entities capable of receiving money into a financial account. By way of example and not limitation, the system may permit users to direct funds to various legal entities such as schools, municipalities, charitable organizations, political campaigns, and for-profit companies as well as direct funds to non-entity financial accounts such as savings accounts, retirement accounts, college and medial savings plans, etc. owned by the user or other individuals.

Practitioners skilled in the art will appreciate that proper database design allows for the association between each user and any number of such organizations and accounts while metadata associated with each such organization and account permits appropriate regulatory, accounting, and tax treatment for each of the organizations and accounts.

The subscribing user who took action in process step 102 interacts with a second authorized affiliate web site B in process step 104. This interaction may occur immediately following the interaction in process step 102 or at any other time. Web site B incorporates into the presented user interface a list of the organizations the user has elected to support, a logical data aggregation service and user interface component called the “basket”. Web site B provides, by way of example, a searchable database of organizations that visitors may wish to support. When the user executes a search and elects to support a retrieved organization E, the distributed network accounting system records an association record containing the organization E, the user, and affiliate web site B from which the election was initiated as in process step 102.

The subscribing user further interacts with a web site A in process step 106. Web site A incorporates into the presented user interface the organizations in the user's basket. By interacting with the basket component of the user interface, the user elects to view the profile of organization E. The web site A retrieves a canonical profile location URL for the organization E from the authoritative organization data system, a component of the distributed network accounting system, and directs the user's client device to the retrieved URL. In process step 108 the user views detailed profile information for organization E at the retrieved URL which is hosted by web site C. Web site C may be an authorized affiliate system of the distributed network accounting system and, if so, may also present the user's basket contents as part of it's user interface.

The subscribing user further interacts with a web site C in process step 110 at any time after accomplishing process steps 102 and 104. The user elects to donate money to one or more of his or her supported organizations, either by transferring funds from a credit card, ACH network, other payment mechanism, or by initiating an e-commerce transaction and diverting a portion of the funds paid to the merchant through the distributed network accounting system using, by way of example, a merchant affiliate network such as Commission Junction, Google Affiliate Network, VigLink, or other similar system. These sources of money for donation are presented by way of example and not limitation. It should be noted that any method by which a user causes cash or a cash equivalent to transfer from an external institution into the system may be used including conversion of airline miles, credit card reward points, merchant loyalty program points, incented volunteering, matching donations and grants, etc.

The available funds from the user's transaction are allocated to the one or more organizations selected by the user. The allocation may be distributed across all organizations in the user's basket on an equal basis, on a weighted basis as specified by the user during previous interaction with the system, or on a weighted basis as specified by the user when initiating this transaction. Alternatively, allocation of funds may be deferred until a fixed or indefinite future time as determined by combining user-specified allocation preferences with defined processing rules.

Those skilled in the art will appreciate that the above described deferral makes it possible for a user to donate funds as described in process step 110 before the user elects to support one or more organizations. In such a scenario, processing rules will defer allocation of donations until such time as the user specifies which organization or organizations should receive the funds. Additional processing rules may provide for methods to elicit allocation preferences from the user, by sending an electronic mail or social network message, for example, and provide a means to automatically select recipient organizations if the user does not specify organizations within a pre-determined time or correlated to a defined event or calendar date.

In process step 112 the accounting services system allocates a portion of the transaction's funds to organization D, identifies the affiliate A responsible for inducing the user's election to support the organization D, and allocates a portion of the transaction's funds to the affiliate A in proportion to the funds allocated to organization D.

In process step 114 the accounting services system allocates a portion of the transaction's funds to organization E, identifies the affiliate B responsible for inducing the user's election to support the organization E, and allocates a portion of the transaction's funds to the affiliate B in proportion to the funds allocated to organization E.

In process step 116 the accounting services system allocates a portion of the transaction's funds to the affiliate C responsible for inducing the user to transfer funds into the accounting system for distribution.

Those skilled in the art will appreciate that a basket user interface may be displayed before the user has elected to support any organizations, and that such displayed user interface may provide additional information educating and inducing the user to take various actions. Similarly, it is not necessary for the user to elect to support more than one organization before initiating a financial transaction.

Those skilled in the art will further appreciate that any number or all of the described user interactions might occur on any one or more affiliate web sites and that the various stages of data processing might be combined into a single user interaction. By way of example and not limitation, web site A might provide both editorial content, a searchable database of organizations, detailed organization profiles, and user interface elements inducing a user to initiate a financial transaction. Similarly, any one or more of the processes of adding an organization to a user's basket, specifying payment allocation, and initiating a financial transaction may be implemented in a single transaction using user-provided data, stored profile data previously provided by the user, or system-defined configuration.

In one envisioned implementation of the system, the user interface presented in process steps 102, 104, 106, and 108 may contain an advertisement for a product or service, the purchase of which will cause funds to be allocated to the user's basket as in process step 110. The advertisement to be displayed may be a general offering or selected by correlating known metadata associated with the user to metadata associated with a number of advertisements, the most strongly correlated of which is displayed. In such an implementation two or more of the individual processing steps previously described may occur in sequence without user interaction, up to and including the entire sequence from the user selecting an organization through financial transaction and allocation.

In another envisioned implementation of the system, the user interface presented in process steps 102, 104, 106, and 108 may contain a notice that the user has funds available for donation and may initiate action to allocate the funds to one or more organizations, and such action may be correlated to the content of the user interface. By way of example, if the user interface presents mention of a single organizations, the user may elect to allocate available funds to the organization. Further, if the user interface presents mention of multiple organizations, some or all of which may be associated with the user via previous activity, the user may elect to allocate available funds to all so-associated organizations or all presented organizations.

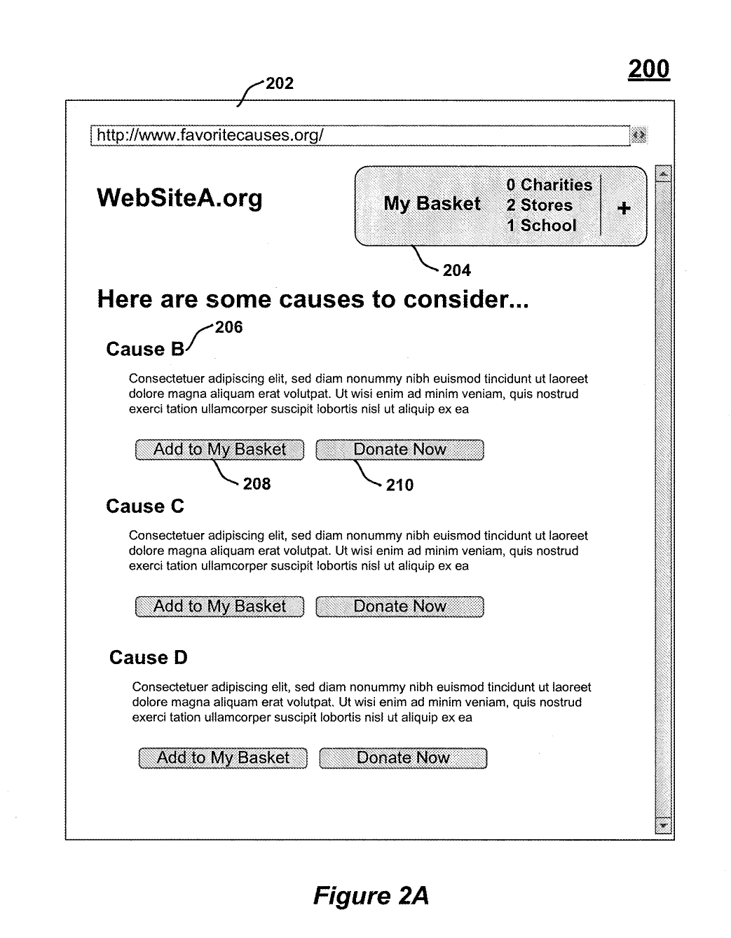

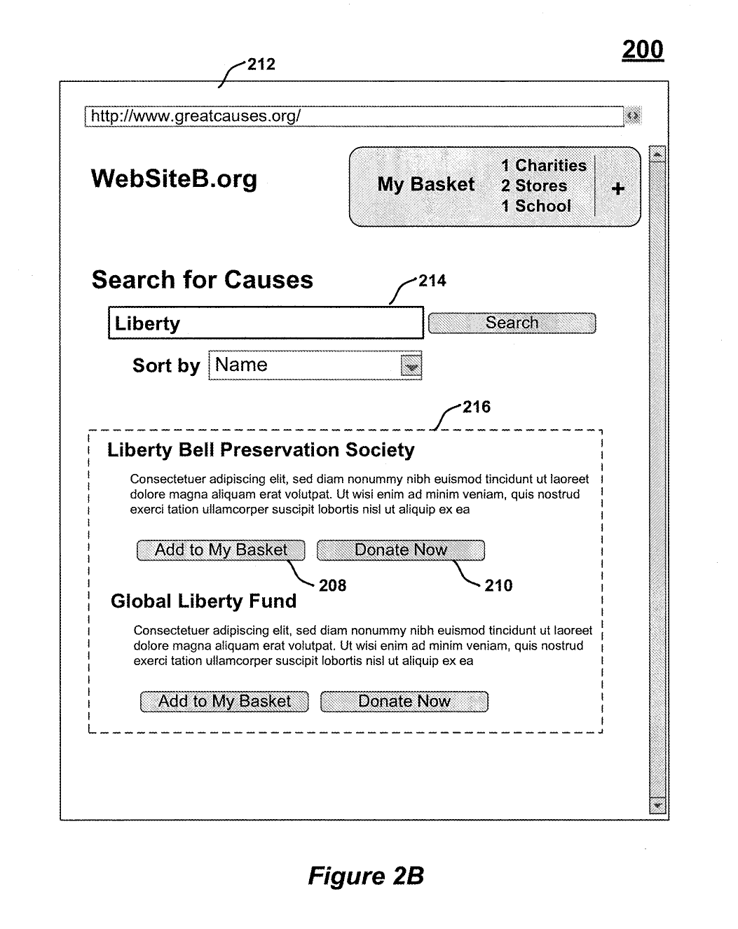

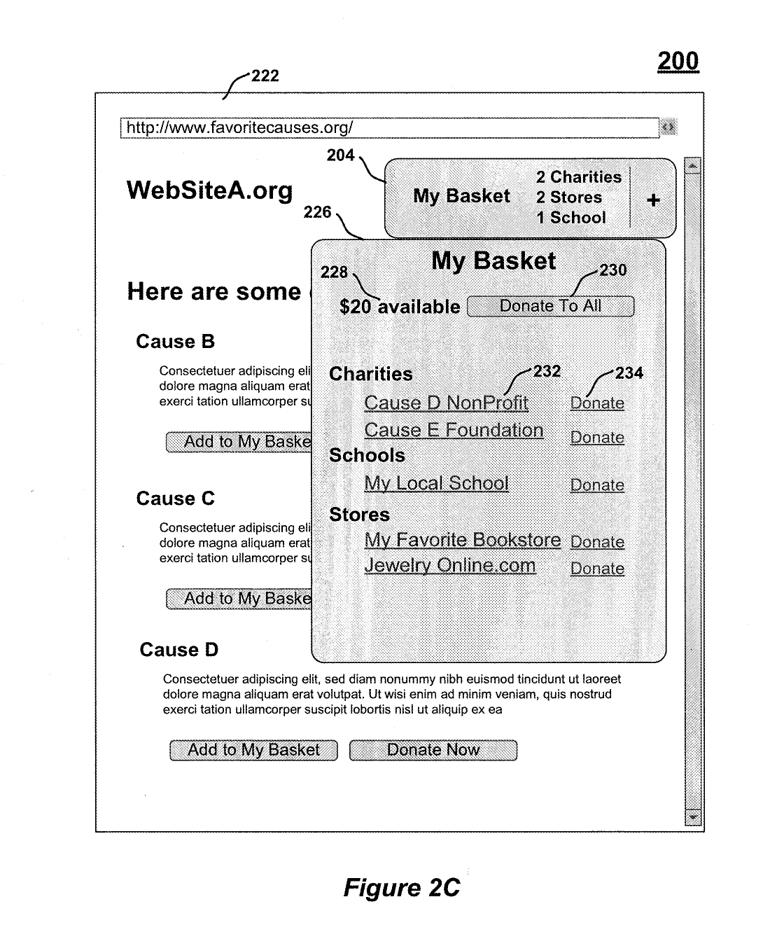

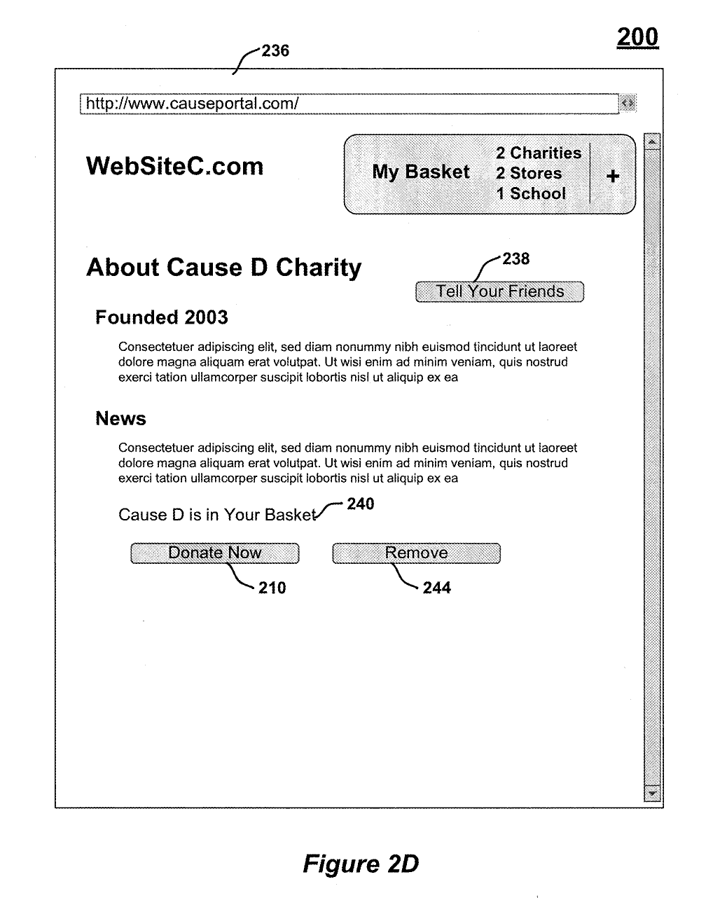

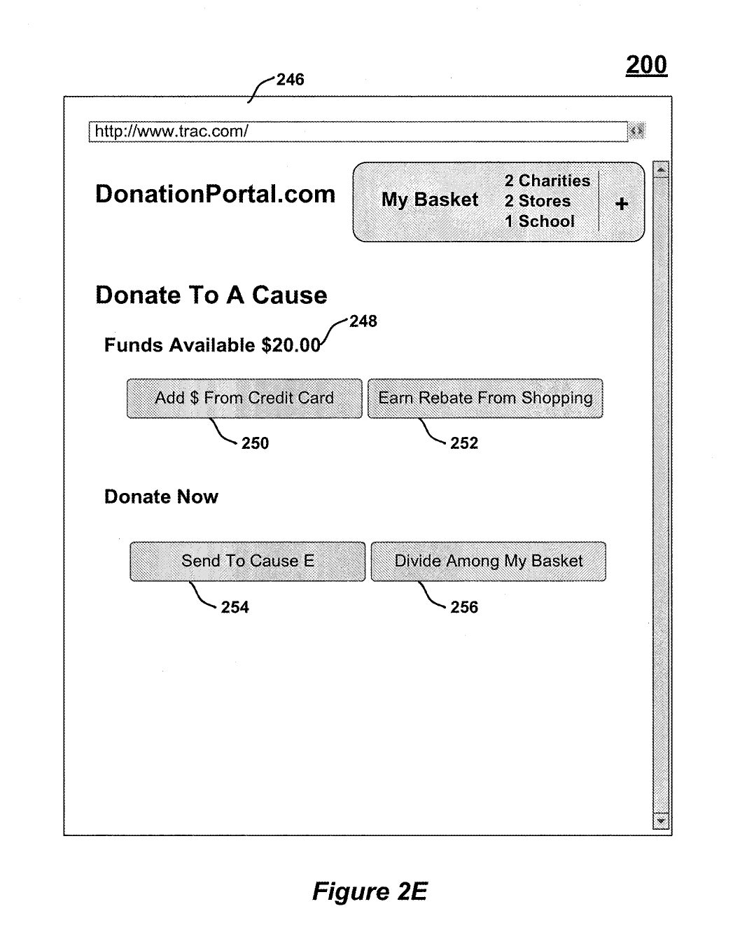

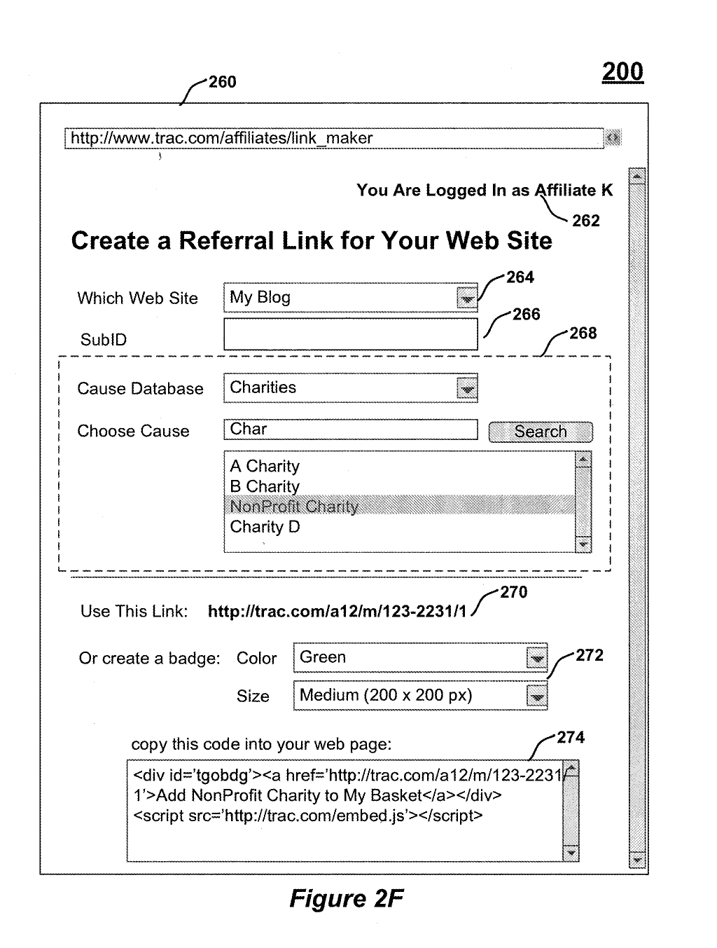

FIG. 2A presents one embodiment of an illustrative user interface related to one aspect of process step 102 in which a user views cause-related information and elects to add the cause to the user's basket. Web page 202 presents informational content and user interface elements presenting the organizations in the viewing user's basket, the name and description of one or more organizations, and one or more actions the user may initiate in conjunction with each organization.

In one embodiment, interface element 204 presents a summary of the user's basket data, indicating the count of each of several categories of organizations the user has elected to support. Element 204 may respond to user input, displaying more detailed information about the user's basket data and providing further actions. By way of example and not limitation, element 204 categorizes the organizations associated with the viewing user's basket into three groups: charities, stores, and schools.

Those skilled in the art will appreciate that such categorizations may be derived automatically from profile data and metadata for the organizations, from external data sources, or specified by one or more data curators. In this example, organizations may be determined to belong to the “charities” category based on the organization's taxing identifier appearing in a database of recognized charitable non-profit organizations, such as that published by the United States Internal Revenue Service covering tax-exempt 501(c)3 organizations. Organizations may be determined to belong to the “stores” category based on the organization being listed in a merchant database or a merchant affiliate network system. Organizations may be determined to belong to the “school” category based on the organization being listed in a municipal or other governmental directory and verified by a trusted data curator. The above implementation details are meant to be representative and in no way the exclusive means of categorizing organizations.

Those skilled in the art will further appreciate that many possible categorizations exist and that any one organizations may be classified into zero, one, or more categories. The names of categories implemented and the methods used to classify organizations thereunto may be dictated by editorial decisions of the system's operator, by legal requirements of the jurisdictions wherein the system is operated, by information architects and interaction designers according to their practice, or by any other reason that may be reduced to practical implementation.

In one embodiment, interface element 206 presents information on a specific organization the user may be interested in supporting. The information may comprise text, images, video, and any other media commonly used to communicate information on the Internet, and may be presented in part, in whole, or in conjunction with additional information collected from many sources.

In one embodiment, interface element 208 is a user input element enabling the user to direct the distributed network accounting system to add the associated organization to the user's basket. Element 208 may be a static element of the web page, created by the author of the web page and presented identically to each user viewing the interface. Alternatively, element 208 may be dynamically generated and customized both in content, presentation, and action based on data contained within the distributed network accounting system, the web server providing the user interface, or other accessible data source.

In one embodiment, interface element 210 is a user input element enabling the user to direct the distributed network accounting system to initiate a financial transaction benefiting the associated organization and any number of other organizations associated with the user's basket. Element 210 may be a static element of the web page, created by the author of the web page and presented identically to each user viewing the interface. Alternatively, element 210 may be dynamically generated and customized both in content, presentation, and action based on data contained within the distributed network accounting system, the web server providing the user interface, or other accessible data source.

FIG. 2B presents one aspect of an illustrative user interface related to process step 104 in which a user searches for a cause and elects to associate the cause with the user's basket. In one embodiment, web page 212 presents user input elements 214, with which a user specifies various criteria for searching one or more cause databases. By way of example and not limitation, in one embodiment, user interface 214 provides for user input of free text keywords matching the name or description of desired organizations and a multiple-choice selection input element for specifying the means by which results should be ordered for presentation.

In one embodiment, user interface element 216 presents organizations from the one or more databases maintained by the system that match the criteria specified by the user. Information about each organization, such as the legal name and a mission statement or description, for example, are presented along with user interface elements enabling the user to initiate various actions associated with each the organization.

In one embodiment, interface elements 208 and 210 are presented in association with each organization presented in element 216.

Those skilled in the art will appreciate that FIG. 2B presents the user interface for a domain-specific database search engine, and more generally a computer-implemented method for locating records within a database or documents within a corpus by data and metadata matching. Methods of implementing such a search engine are commonly know and widely described, including open source software implementations of search engines such as Sphinx, as documented in Introduction to Search with Sphinx by Andrew Aksyonoff (O'Reilly Press, 2011, ISBN 978-0-596-80955-3).

Those skilled in the art will further appreciate that the presented interface for textual keyword matching and result sorting is exemplary and in no way limits the described application. Database search engines commonly expose multiple levels of complexity in their user interface and provide both very broad and very specific data and metadata matching features. The described embodiments are envisioned to make use of any and all such levels. An example of such a described search engine is the United States Patent and Trademark Office's Online Patent Search Engine, PatFT, which exposes multiple methods of searching the patent database at http://pafft.uspto.gov/netahtml/PTO/search-bool.html, http://pafft.uspto.gov/netahtml/PTO/search-adv.htm, and http://pafft.uspto.gov/netahtml/PTO/srchnum.htm.

FIG. 2C presents one aspect of an illustrative user interface related to process step 106 in which a user views the causes stored in the user's basket. In one embodiment, web page 222 presents dynamic user interface element 204, which provides a summary of the status of the user's basket. When the user interacts with the element by, for example, moving their mouse over the element, selecting it with a keyboard command, or clicking on it, user interface element 226 is displayed containing detailed information pertaining to the user's basket associations.

In one embodiment, user interface element 228 presents a summary of the funds currently available to the user to allocate to one or more causes. The total of funds displayed is derived from donation activity initiated by the user as in process 110, funds generated as commissions from processes such as 112, 114, and 116, and other sources of funds. The total may reflect only deposited funds that the distributed accounting system has cleared, or it may include pending financial transactions that have not yet cleared but are reported from various institutions as due.

In one embodiment, user interface element 230 presents a button that, when clicked, initiates allocation of the available funds to all organizations in the user's basket according to system-defined and user-defined allocation preferences as described in process 110.

In one embodiment, user interface element 226 further provides a detailed list of the organizations associated with the user's basket. By way of example and not limitation, the organizations are listed under the same classifications as presented in element 204. Each organization is presented as a hyperlink 232, which when clicked directs the user's client device to an information page about the associated organization.

Next to each organization's hyperlink is an additional hyperlink 234 which, when clicked, initiates a donation to the associated organization and zero or more other organizations, the function of which is as described for the embodiments of the user interface element 210 disclosed herein.

The information and user interface elements presented within the embodiment of element 226 of FIG. 2C are exemplary of information and elements that may be so presented and are presented by way of example and not limitation. Those skilled in the art will appreciate that various information associated with, and actions related to, each presented organization may be incorporated into the user interface. Practitioners will further appreciate that user interaction with element 204 may, rather than displaying element 226 within the existing web page, cause the user's client device to navigate via hyperlink to a new web page presenting the contents of element 226.

FIG. 2D presents one aspect of an illustrative user interface related to process step 108 in which a user views cause profile information at the canonical URL for the cause. In one embodiment, web page 236 presents a variety of information about an organization or account that may be associated with the user's basket. The example presents the legal name of the organization, the year it was founded, a description or mission statement, and an abstract of recent news relating to the organization. Those skilled in the art will appreciate that the type of information presented may change from organization to organization and be contained within internal databases or retrieved from external information systems by, for example, automated retrieval of RSS data feeds. In the case of entities with personal associations, such as financial accounts, the information presented may include the user's account number or other personal information.

In one embodiment, user interface element 238 provides a method for the user to transmit an electronic message to other users pertaining to the displayed organization. The specific implementation of the transmission may, by way of example and not limitation, utilize a mailto: hyperlink that causes the user's client device to compose an electronic mail message, incorporation of an API from a third party such as the Facebook Like button (https://developers.facebook.com/docs/reference/plugins/like/), or incorporation of third party communications software such as AddThis (http://www.addthis.com/).

The hyperlinks used in the messages may contain a unique identifier associated with the user initiating the communication and each unique action taken by the user. When a user accesses the distributed accounting system via a hyperlink so shared, the accounting system can use the identifiers to determine the user and action responsible for referring the referred user. When a referred user initiates actions such as adding an organization to user's basket or initiating a donation, the referring user may be considered a Site Operator as in processes 102, 104, and 108, and the referring user may receive a commission as in processes 112, 114, and 116.

In one embodiment, user interface element 240 provides an indication of the status of the viewed organization with respect to the viewing user. By way of example and not limitation, if the user has added the organization to her basket, element 240 will notify her of that fact. Similarly, if the user has recently donated to the organization, the amount and date of his last donation may be displayed.

In one embodiment, user interface element 210 is presented in association with the displayed organization.

In one embodiment, user interface element 208 may be presented in association with the displayed organization. If the organization is already associated with the viewing user's basket, however, user interface element 244 may be displayed instead. In one embodiment, element 244 enables the user to initiate a process whereby the organization is no longer associated with the user's basket for future activity. The distributed accounting system retains the association for past transactions in order to facilitate in-progress allocations as well as auditing, compliance, and other required functions.

FIG. 2E presents one aspect of an illustrative user interface related to process step 110 in which a user elects to donate to one or more causes. In one embodiment, web page 246 shows an exemplary user interface displayed to the user when she initiates a donation action, as by clicking user interface elements 210 or 230. In one embodiment, user interface element 248 displays the funds currently available for the user to allocate, as determined by the unallocated transactions contained within the distributed accounting system.

In one embodiment, user interface element 250 enables the user to initiate a financial transaction whereby he transfers money from an external financial account such as a bank or line of credit into the accounting system. Those skilled in the art will appreciate that the process of executing a funds transfer may be accomplished by, for example, using a web-based payment portal similar to an e-commerce payment solution (http://www.paypal.com/) or a banking web site.

In one embodiment, user interface element 252 enables the user to initiate a funds transfer into the accounting system by means of a merchant affiliate network shopping platform, such as those operated by Upromise (http://shop.upromise.com/). Additional methods of generating a funds transfer may be presented to the user. By way of example and not limitation, envisioned methods include converting reward points from an affiliated businesses' loyalty program (http://www.membershiprewards.com/homepage.aspx) or an affiliated rewards program for social activism (http://www.dogoodgetrewards.com/).

In one embodiment, user interface element 254 enables the user to initiate a funds allocation where all available funds are allocated to the single organization displayed. As related in process 110, percentages of the available funds may be distributed to various parties as commissions, while all user-directable funds will be allocated to the single organization.

In one embodiment, user interface element 256 enables the user to initiate a funds distribution to all organizations associated with the user's basket. Available funds are split among the organizations in the user's basket equally, according to weights previously assigned by the user, or according to system-defined weights associated with various organizations.

Those skilled in the art will appreciate that additional information and user interface elements related to funds donation may be presented within web page 246, including additional methods for transferring funds into the user's account and interface elements required for the user to assign allocation weights to one or more organizations at the time of allocation.

The disclosed embodiments contemplate the addition of so-called Social Network Sharing user interface elements enabling the user to transmit electronic messages via various communications systems informing the user's contacts that she has transferred funds into the system and/or allocated funds to one or more organizations. Those skilled in the art will appreciate that such functionality can be accomplished by using APIs provided by various messaging systems (Twitter Tweet Button, http://dev.twitter.com/pages/tweet_button, for example) or third party software such as AddThis.

FIG. 2F presents one aspect of an illustrative user interface related to system flow diagram 700 in which an authorized representative of an affiliate publisher creates a tracking hyperlink associating the publisher with a cause, or the distributed accounting system in general, for use on the publisher's web site. In one embodiment, web page 260 presents an interactive application used for configuring and then publishing tracking links.

In one embodiment, user interface element 262 displays identifying information for the currently authenticated user, which will be the user credited for all activity generated by the created link and thus the commission recipient.

In one embodiment, user interface element 264 provides a list of the authorized affiliate web sites managed by the authenticated user, as contained within the distributed accounting system's affiliate database. The user selects the web site on which they intend to publish the created link, or selects an option indicating they will be publishing the link on a third-party web site or electronic messaging service such as email.

In one embodiment, user interface element 266 is a text input field where the user may input a free-form tracking code. This code is added to the generated link and will be associated with aggregate usage data provided by the distributed accounting system to the affiliate user. Those skilled in the art will appreciate that such functionality is common in so-called Merchant Affiliate Network systems, such as that operated by Commission Junction (http://www.cj.com/).

In one embodiment, user interface element 268 provides a user interface for searching the system's databases of causes and selecting a cause to associate with the generated link. By way of example and not limitation, the interface provides a list of databases known to the system and a text entry field for keyword search. The user may interact with element 268 to explore and filter the list of available causes and then select a single organization, cause, financial service, or other entity. If an entity is selected, the hyperlink will direct referred users to information related to the entity. Otherwise, referred users will be presented with more general information related to the accounting system in general or a set of causes selected by the distributed accounting system via system-defined means (such as a random selection of entities from databases, entities identified by editorial staff, or entities determined by correlation of entity metadata to known user or referrer profile data.

In one embodiment, user interface element 270 displays the hyperlink generated by the distributed accounting system that correlates the affiliate user, the web site selected in element 264, if any, the tracking code entered in element 266, if any, and the cause selected in element 268, if any. The user may copy the displayed hyperlink and incorporate it in a web site, electronic communications, other external information systems, or written communications of any type.

In one embodiment, user interface element 272 enables the user to create a dynamic user interface element, an HTML “badge”, that may be incorporated into a web page, electronic communications message, or other document in lieu of the hyperlink. The user specifies one or more display attributes for the badge. By way of example and not limitation, element 272 provides for selection of the size and color of the user interface element to be created. User interface element 274 displays the hypertext markup code necessary to embed the badge as configured into the user's document.

Those skilled in the art will appreciate that such HTML badges are in common use on the Internet, and may be configured with a wide array of display and behavior options. Exemplary implementations include the Facebook Like button and the AddThis sharing button, which provide various display configuration options and then present HTML code to be embedded in the publisher's web page.

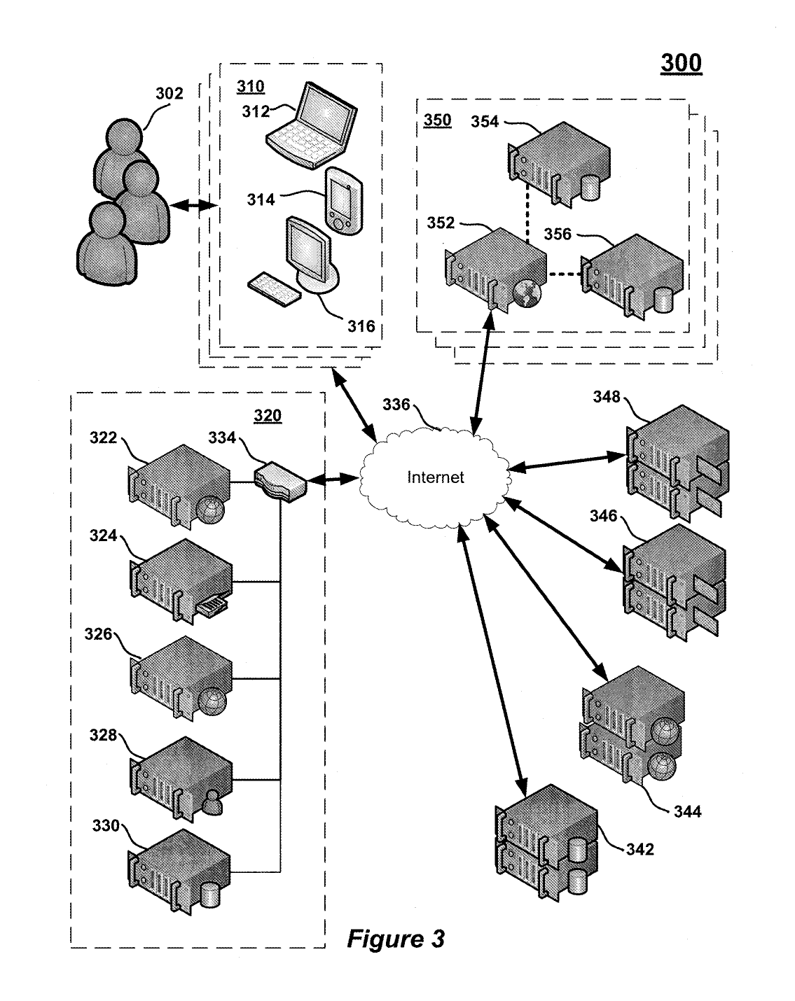

Referring to FIG. 3, system 300 comprises one embodiment of a distributed network accounting system 320 coupled to a multiplicity of information distribution systems 350, financial transaction processing systems 348, vendor fulfillment systems 346, affiliate accounting systems 344, and organization database systems 342, wherein subscribers 302 retrieve information about organizations, indicate their interest in supporting the organizations, and initiate transactions using any of a number of client devices 310 to effect transactions between respective subscribers 302 and any of a number of merchants within vendor fulfillment systems 346 and financial institutions within financial transaction processing systems 348.

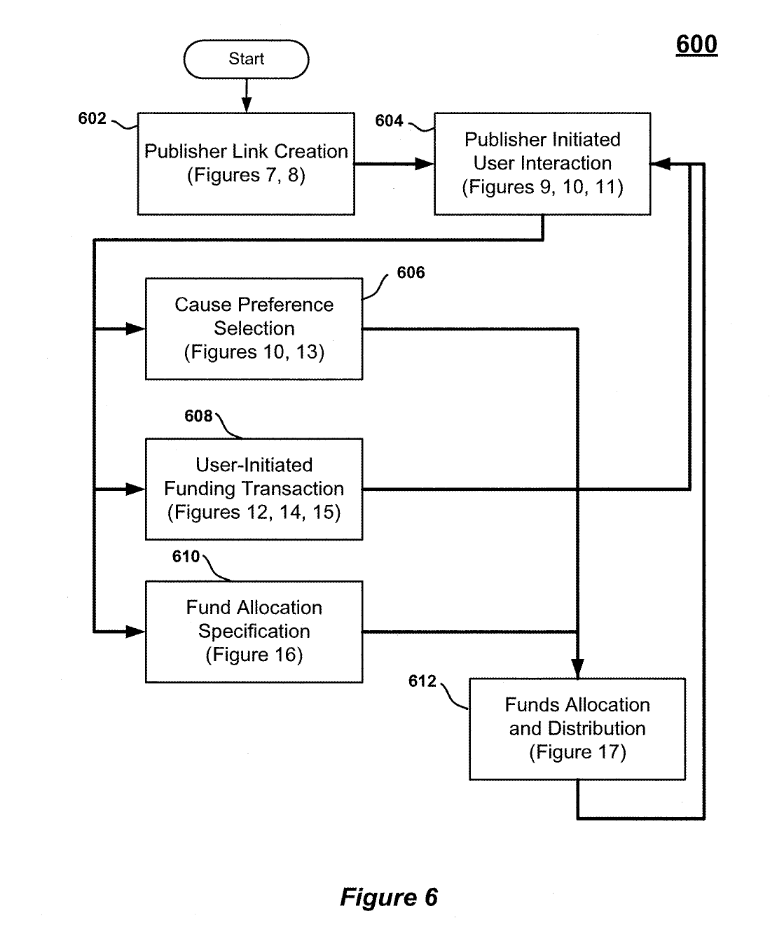

The overall operation of distributed network accounting system 320 is controlled by basket services server 322. In one embodiment, basket services server 322 is an application server whose operation is further described in conjunction with FIGS. 6-17. Basket services server 322 may communicate with affiliate authentication server 324, organization data server 326, user registration server 328, and database management server 330 via a conventional local area network (LAN) using Internet-protocol router 334 to coordinate and control the overall operation of distributed network accounting system 320.

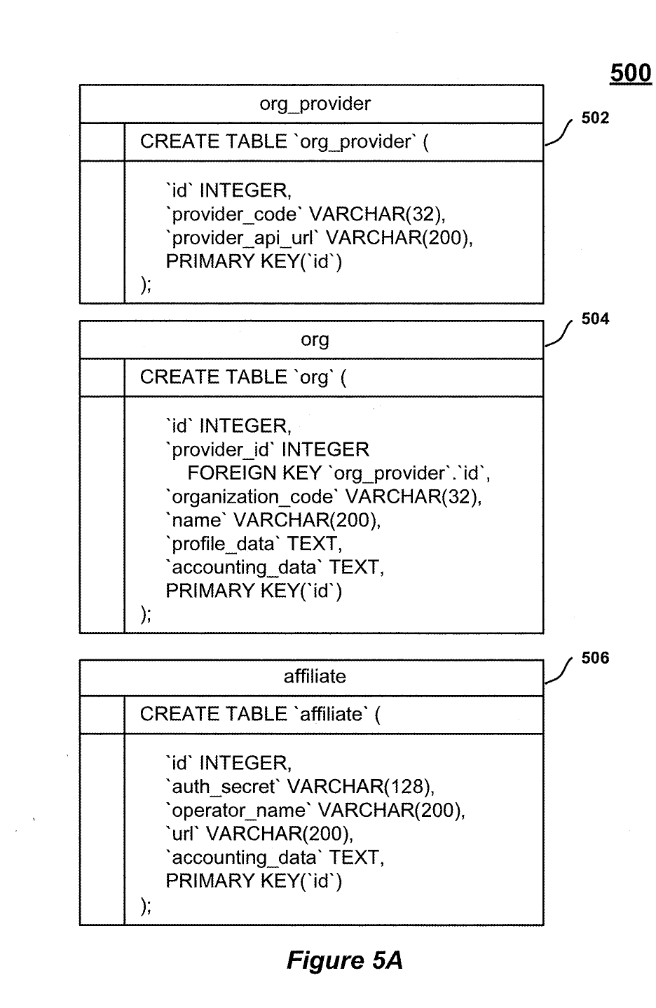

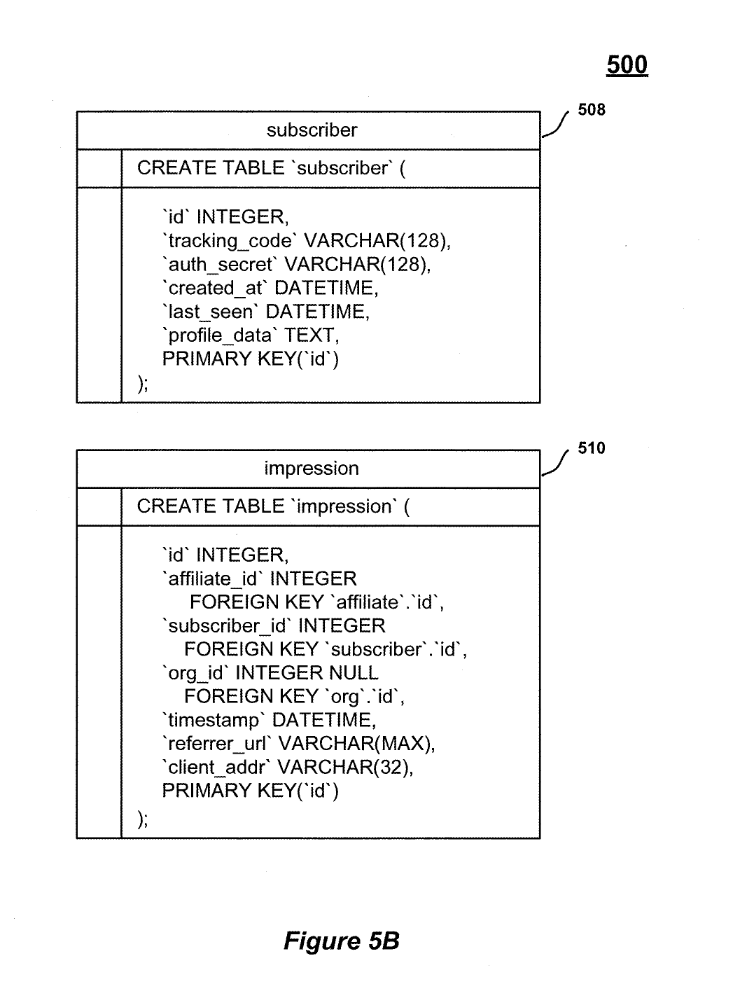

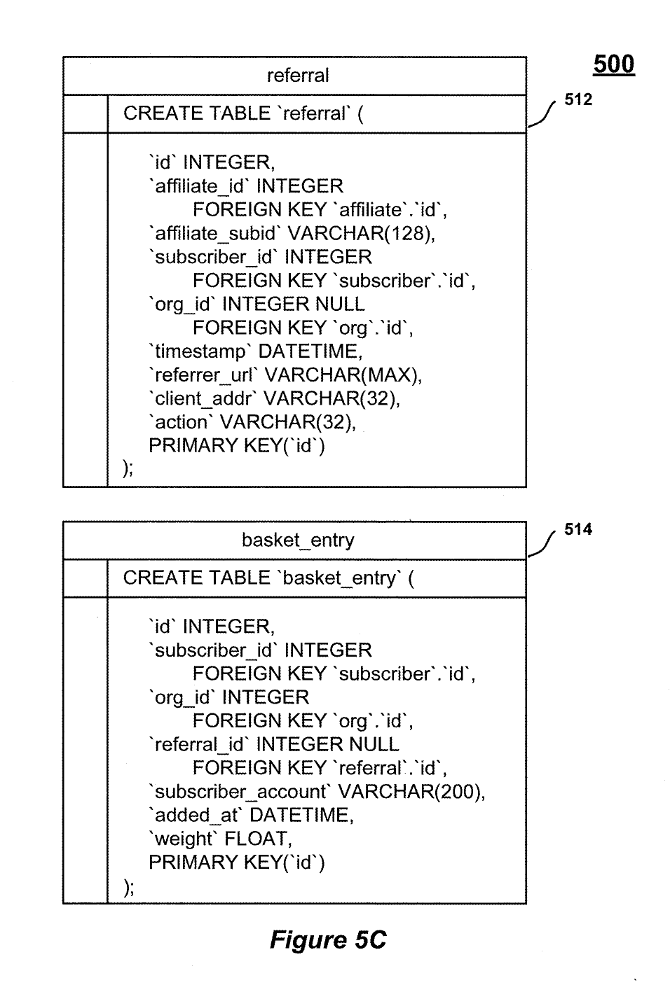

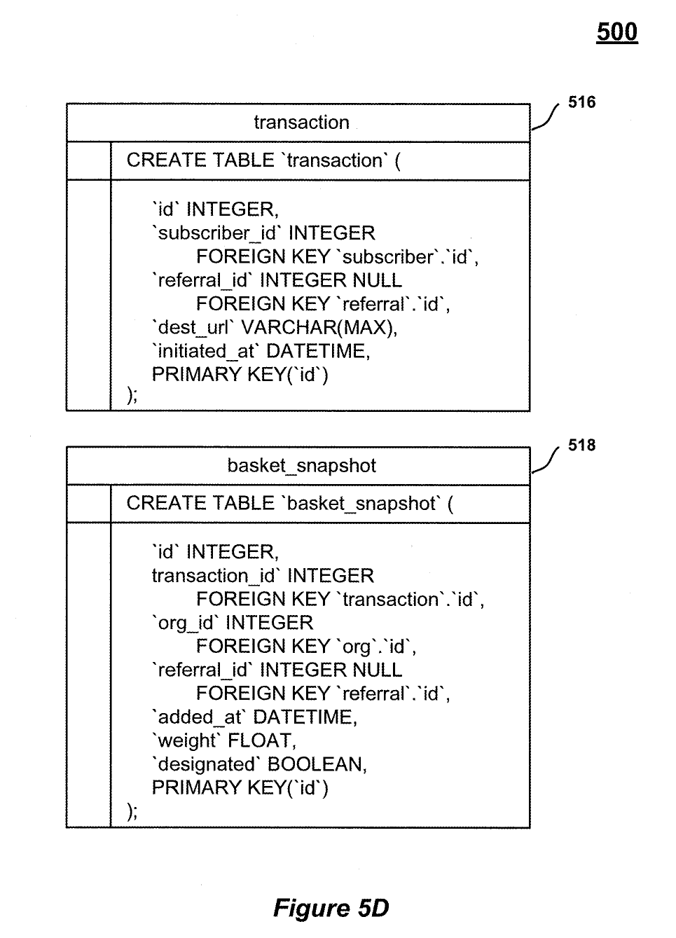

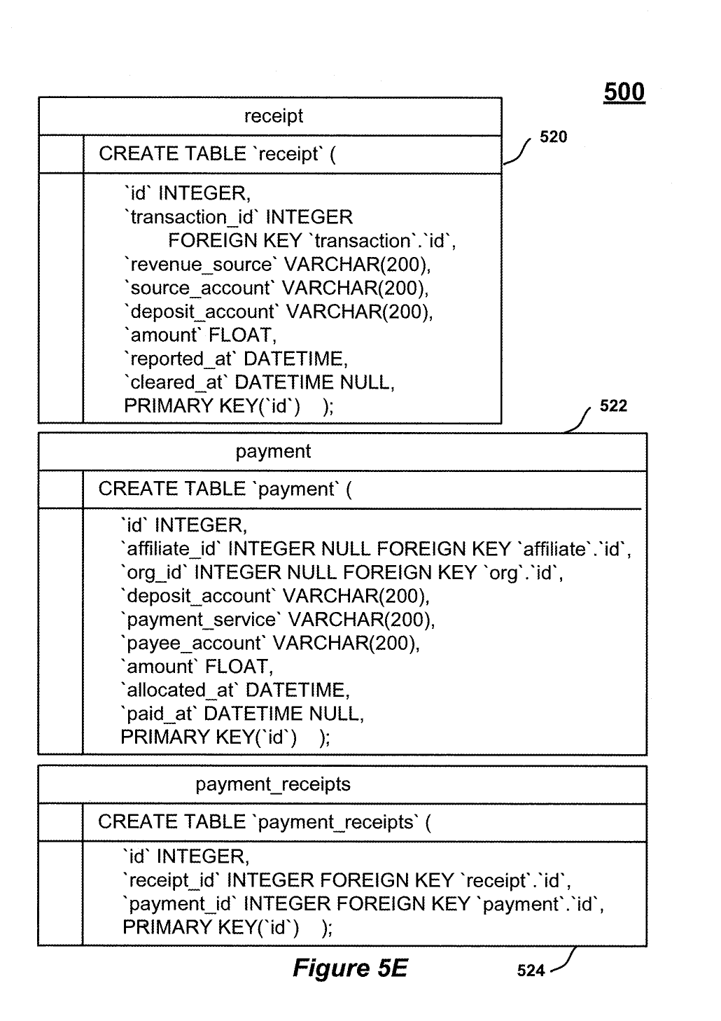

Those skilled in the art will appreciate that database management server 330 may comprise relational database management system (RDBMS) software or other forms of data storage software operating on one or more computer systems and managing tables of data with defined schema or arbitrary data retrievable by unique identifiers or queries, and that the software may operate on an application or web server system utilizing operating system communication protocols or operate on one or more discrete server systems utilizing LAN- or WAN-based communication protocols such as IP. FIGS. 5A-5E show a pseudo-code depiction of one aspect of a data schema of tables managed by database management server 330.

In one embodiment, basket services server 322 may communicate with organization database servers 342, affiliate network accounting servers 344, vendor fulfillment systems 346, financial transaction processing systems 348, information distribution systems 350, and client devices 310 using Internet-Protocol (IP) data transmission through router 334 which is adapted for communication via conventional wide-area network (WAN) connections such as those deployed over Internet 336.

Respective subscribers 302 initiate transactions through one of information distribution systems 350 through respective web server 352 which provides information incorporating reference to one or more of organizations known to organization data server 326 as further described herein, and the respective subscriber indicates interest in one of the organizations by interacting with one of user interface elements 208, 210, 232, 234, 238, 244, 250, 252, 254, 256 or similar. Web server 352 causes the subscriber's client device 310 to connect to basket services server 322, conveying the identity of the web server 352's associated information distribution system 350, a tracking code used by organization data server 326 to identify the indicated organization, the type of interest represented by the user interface element, and optional additional tracking codes defined by the information distribution system 350.

Those skilled in the art will appreciate that the information distribution system 350 may comprise a member database 354 and/or an organization database 356 for use within the information distribution system. Further, a subset of member profiles contained in member database 354 may be correlated to a subset of subscriber profiles contained in user registration server 328 via shared identifiers, and a subset of organization profiles contained in organization database 356 may be correlated to a subset of organization profiles known to organization data server 326 via shared identifiers, and that information displayed by the information distribution system 350's associated web server 352 may combine data from the member database 354 and organization database 356, including inclusion or modification of information and user interface elements based on the existence of the correlations.

Upon establishing a connection with client device 310, basket services server 322 identifies the client device 310 as an existing or new subscriber device via communication with user registration server 328, which provides a unique identifier for the identified subscriber; authenticates the identity of the referring information distribution system 350 via communication with affiliate authentication server 324; and stores a subscriber identifier in conjunction with information conveyed from the web server 352 in database management server 330 as further described herein. Those skilled in the art will appreciate that the identification may be performed by utilizing a database of known subscribers, each associated with a unique identifier, and a method of associating a client device with the identifier, such as hypertext transport protocol (HTTP) cookies, client device 310 IP address, or a unique device identifier provided by the client device.

In one embodiment, basket services server 322 further retrieves profile data associated with the organization of interest via communication with organization data server 326. Basket services server 322 correlates the type of interest expressed by subscriber's initiating action with the organization profile, calculates a URL from the correlated data as further described herein, and directs the client device 310 to the calculated URL, causing client device 310 to connect to one of information distribution systems 350, financial transaction processing systems 348, vendor fulfillment systems 346, or affiliate accounting systems 344, as appropriate to enact the user 302's intended interest.

In one embodiment, basket services server 322 further correlates the user's expressed type of interest to accounting rules and, based on the correlation, may store an association between the subscriber, the organization, the type of interest, timestamp, and additional data and metadata in database management server 330.

Those skilled in the art will appreciate that the organization profiles known to organization data server 326 may be derived from tables contained in database management server 330 in addition to one or more remote data hosting servers 342, each containing profile information for one or more organizations and accessed by organization data server 326 utilizing an application programming interface (API).

Those skilled in the art will further appreciate that the communication between client device 310 and basket services server 322 may instead occur between web server 352 and basket services server 322, in which case web server 352 communicates on behalf of client device 310 by providing the identifier of the client device 310's subscriber 302 to basket services server 322. In such an implementation basket services server 322 authenticates the web server 352's associated information distribution system 350 and verifies the system's authorization to act on behalf of the subscriber via affiliate authentication server 324, processes the requested transaction, and provides transaction results and the appropriate destination URL, if any, to the web server 352. Web server 352 processes the response from basket services server 322 and updates information displayed to the subscriber 302 or directs the client device 310 to the destination URL.

When web server 352 transmits information incorporating one or more organizations to the client device 310, the information may incorporate hypermedia including images, hyperlinks, and executable code implemented in a computer language such as JavaScript. Those skilled in the art will appreciate that such incorporation is described in the specification for hypertext markup language (HTML), and that both the hypermedia elements described and the language HTML are exemplary and not restrictive.

One or more of the hypermedia elements may specify a uniform resource locator (URL) that indicates basket services server 322. Client device 310, when displaying the information, connects to basket services server 322 to retrieve the hypermedia resource using, by way of example, the HTTP protocol. Basket services server 322 identifies the existing or new subscriber associated with the client device 310 as previously described herein and stores the subscriber identifier in conjunction with information conveyed from the hypermedia URL and HTTP request in database management server 330 as further described herein.

Upon establishing a connection with client device 310 after referral via calculated URL as described in paragraph [0087], affiliate accounting system 344 provides a user interface utilized by initiating subscriber 302 to enter electronic funds transfer instructions. The instructions comprise the dollar value of the funds transfer; account identifiers, institution routing numbers, and authentication information as required for the institutional account; and approval of transaction request. Upon completion of processing user input and verification of information, affiliate accounting system 344 transmits a transaction report to basket services server 322. Basket services server 322 records the transaction and the associated subscriber 302 as further described herein. Furthermore, affiliate accounting system 344 transmits funds transfer instructions to the originating and receiving financial institutions designated by the transaction to effect a transfer of funds from the initiating subscriber to an account designated by the operator of the distributed network accounting system 320. Upon receipt of the funds transfer, basket services server 322 records the funds receipt correlated to the transaction as further described herein.

Upon establishing a connection with client device 310 after referral via calculated URL as described in paragraph [0087], the referred affiliate accounting system 344 presents a list of authorized vendor fulfillment systems to the initiating subscriber 302 via a user interface presented on the subscriber's client device 310. The user interface includes profile information pertaining to the vendor fulfillment systems, details of specific payment arrangements provided by each the vendor fulfillment systems, and searchable lists of products and services available from each the vendor fulfillment system. The initiating subscriber 302 uses the presented information to select one of vendor fulfillment systems 346. The client device 310 transmits the selection to affiliate accounting system 344 which directs client device to connect to the selected vendor fulfillment system 346.

Upon establishing a connection with client device 310 after referral from the affiliate accounting system 344 or via calculated URL as described in paragraph [0087], the referred vendor fulfillment system 346 presents a user interface to the subscriber 302.

Upon completion of a product or service purchase by the client, the vendor fulfillment system 346 transmits a purchase report to one of affiliate accounting systems 344 which in turn transmits the purchase report to basket services server 322 where the purchase is recorded in association with the initiating subscriber 302 as further described herein. Upon receipt of payment from the subscriber 302, the vendor fulfillment system 346 transfers a portion of the purchase price to an account designated by the affiliate accounting system 344 according to agreements negotiated between respective vendor fulfillment systems 346 and affiliate accounting systems 344, and the affiliate accounting system 344 transfers a portion of received funds to an account designated by the operator of the distributed network accounting system and transmits a funds receipt report to the basket services server 322, which records the funds receipt correlated to the purchase.

Those skilled in the art will appreciate that the described operation of each affiliate accounting system 344 is descriptive of existing comparison shopping, loyalty shopping, and merchant affiliate network computer systems, examples of which include PopShops at http://www.popshops.com/, MyCoupons at http://www.mycoupons.com/, and Commission Junction at http://www.cj.com/; and that the described operation of each vendor fulfillment system 346 is descriptive of Internet-based retail merchants, an example of which is Walmart at http://www.walmart.com/. Those skilled in the art will further appreciate that the described implementation is exemplary and other methods of connecting the subscriber interest, purchases, and payments are envisioned including in-person purchases at retail stores by associating credit, debit, or loyalty card numbers with respective subscribers and soliciting fees from merchants via merchant processing services and various other interfaces to financial institutions and merchants as commonly known to the practitioners.

Upon establishing a connection with client device 310 after referral via calculated URL as described in paragraph [0087], the referred financial transaction processing system 348 provides a user interface utilized by initiating subscriber 302 to enter electronic funds transfer instructions. The instructions comprise the dollar value of the funds transfer; account identifiers, institution routing numbers, and authentication information as required for the institutional account; and approval of transaction request. Upon completion of processing user input and verification of information, the financial transaction processing system 348 transmits a transaction report to basket services server 322. Basket services server 322 records the transaction and the associated subscriber 302 as further described herein. Further, the financial transaction processing system 348 transmits funds transfer instructions to the originating and receiving financial institutions designated by the transaction to effect a transfer of funds from the initiating subscriber to an account designated by the operator of the distributed network accounting system 320. Upon settling of the funds transfer into the recipient account, basket services server 322 records the funds receipt correlated to the transaction as further described herein.

Those skilled in the art will appreciate that the described operation of financial transaction processing system 348 is descriptive of numerous existing electronic payment and funds transfer systems. Examples include Credit Card/ACH payment services operated by PayPal at http://www.paypal.com and online wire transfer services operated by many banks, including Bank of America. Those skilled in the art will further appreciate that the originating hyperlink provided by information distribution system 350 or processing performed by basket services server 322 may determine the dollar value of the initiated transaction and pass the amount to financial transaction processing system 348 such that initiating subscriber 302 is not required to enter the amount.

Those skilled in the art will appreciate that each of the affiliate accounting systems 344, vendor fulfillment systems 346, and financial transaction processing systems 348 may store preference, payment and authentication data associated with each initiating subscriber such that the subscriber is not required to re-enter the information upon repeated usage, and that basket services server 322 may store profile information on each the subscriber indicating which of several the affiliate accounting systems 344, vendor fulfillment systems 346, and financial transaction processing systems 348 each respective subscriber should be referred to when initiating actions.

Those skilled in the art will appreciate that the various servers and devices of distributed computer system 300 are adapted to send, receive and route network communications using conventional internet connections and protocols which may include HTTP, HTTPS, IPV4, IPV6, TCP/IP and/or any of a number of networking protocols adapted for data communication via the Internet 336.

Those skilled in the art will further appreciate that the respective client devices 310 which may include a laptop computer 312, an internet enabled “smart phone” 314, and a conventional desktop computer system 316, are each shown by way of example and not limitation.

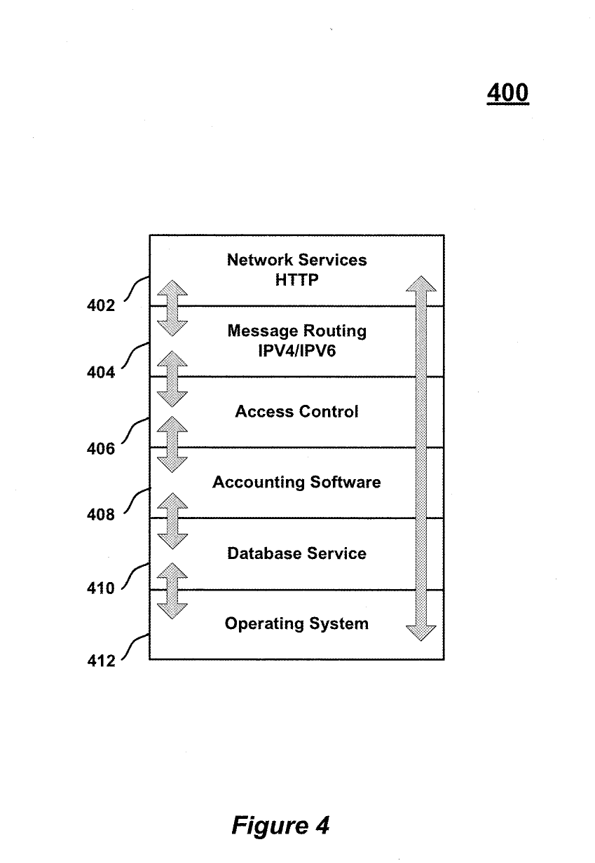

As noted above, in one embodiment, distributed network accounting system 320 includes a basket services server 322 which is an application server that coordinates the overall operation of distributed computer network 300 as defined by the API shown in FIG. 4, the schema shown in FIGS. 5A-5E, and the associated system flow diagrams shown in FIGS. 6-17.

FIG. 4 is a diagram of one aspect of an application program interface (API) 400 which is used to control the overall operation of one embodiment of the distributed network accounting system 320. The API is hosted in one embodiment of basket services server 322 within distributed network accounting system 320 and operates in association with the schema depicted in FIGS. 5A-5E. API 400 includes application layer 402 which works in cooperation with message routing application layer 404, access control layer 406 which operates in cooperation with operating system layer 412 to provide subscriber network access and authentication to distributed network accounting system 320 via the internet 336.

Upon authentication, subscribers utilize the system and method presented herein via the distributed network accounting system 320 in accordance with accounting services 408 hosted on basket services server 322 as further described herein. The database service 410 is hosted on database server 330 as further described in conjunction with FIGS. 5A-5E.

FIGS. 5A-5E show one aspect of a pseudo-code depiction of a schema constructed in accordance with the requirements of the ISO SQL: 2003 standard published by ISO/IEC. Those skilled in the art will appreciate that the various tables shown in FIGS. 5A-5E provide a relational database wherein the naming conventions shown therein conform to ISO/IEC 9075:2003 which is available from the International Standards Organization at http://vvww.iso.org/.

Schema 500 defines one aspect of operating modules 502-524 which are configured as tables within an ISO SQL: 2003 structure which is invoked in accordance with the system flow diagrams shown in FIGS. 6-17. In accordance with the nomenclature defined in ISO/IEC 9075:2003, a primary key is a direct reference to a defined field or variable within a table or data structure while a foreign key is a referential constraint between two tables. The referencing and referenced table may be in the same table which is referred to as a self-referencing or recursive foreign key. A table may include multiple foreign keys, and each foreign key may have a different referenced table. Therefore, cascading relationships can be established using foreign keys. Those familiar with the art will appreciate that the relationships and cascading relationships may be implemented without formal referential constraints at the data schema level by applying application-level integrity constraints to the primary keys, this allowing for partitioning of the tables across multiple independent database systems or adaptation of the operating modules to non-relational data storage systems.

Org_provider table 502 stores information related to organization database servers 342 and includes unique fields for storing an identifying code and API URL for each respective organization database server 342. Org_provider table 502 defines each respective organization database server as a “primary key” within the ISO SQL: 2003 structure. Org_provider table 502 is used by organization data server 326 to locate and authenticate the organization database servers 342 when communicating over Internet 336.

Org table 504 stores essential information related to each organization, financial account, cause, or other entity for which a subscriber may express interest and includes unique fields for storing the organization code, name, profile information, and accounting data required for processing financial transactions with each respective organization. Org table 504 further includes a field for storing the organization database server 342 that contains each respective organization data record. Org table 504 defines each respective organization as a “primary key” within the ISO SQL: 2003 structure, but further includes a “foreign key” reference to org_provider table 502.

Those skilled in the art will appreciate that the profile information and financial payment information fields in org table 504 may store extensible, structured data adapted to each respective entity for display, accounting, and funds transfer purposes.

Affiliate table 506 stores essential information related to information distribution systems 350 and includes unique fields for storing operator's name, API authentication secret, system “landing page” URL, and accounting data required for processing financial transactions with each respective affiliate organization. Affiliate table 506 defines each respective affiliate as a “primary key” within the ISO SQL: 2003 structure.

Those skilled in the art will recognize that accounting data may include tax identification and taxing entity classification information and payment information including an organization or affiliate's preferred bank account number, bank routing number and routing type. Those skilled in the art will appreciate that accounting and payment processing may be implemented in accordance with the Automated Clearing House (ACH) payment processing regulations established by the National Clearing House Association (NACHA) and the United States Federal Reserve.

Subscriber table 508 stores essential information related to individual subscribers 302 and includes unique fields for storing a tracking code, password, account creation time, last activity time, and extensible profile data. Subscriber table 508 defines each respective subscriber as a “primary key” within the ISO SQL: 2003 structure, and is managed by user registration server 328. Those skilled in the art will appreciate that subscriber records may be created with minimal data, for example containing only a tracking code, and that additional information about the subscriber may be added to the record in future interactions with the system.

Impression table 510 stores information related to interactions described in paragraph [0092], in which hypermedia incorporated into a document induce a client device 310 to retrieve the media from basket services server 322, and includes unique fields for storing the respective affiliate, respective subscriber, respective subject organization, time of retrieval, URL of the respective referring document, and IP address of the client device. Impression table 510 defines each respective interaction as a “primary key” within the ISO SQL: 2003 structure, but further includes “foreign key” references to affiliate table 506, subscriber table 508, and org table 504. Those skilled in the art will appreciate that the foreign key to org table 504 is an optional reference and may store a NULL value for interactions in which a specific organization is not referenced.

Referral table 512 stores information related to interactions described in paragraphs and [0086], in which a subscriber 302 initiates an action with the system, and includes unique fields for storing the respective affiliate, affiliate-specified tracking identifier (a “SUBID”, as commonly defined by merchant affiliate tracking systems such as Commission Junction), respective subscriber, respective subject organization, time of retrieval, URL of the respective referring document, IP address of the subscriber's client device 310, and the type of interest or action indicated by the subscriber. Referral table 512 defines each respective interaction as a “primary key” within the ISO SQL: 2003 structure, but further includes “foreign key” references to affiliate table 506, subscriber table 508, and org table 504. Those skilled in the art will appreciate that the foreign key to org table 504 is an optional reference and may store a NULL value for interactions in which a specific organization is not referenced.

Basket_entry table 514 stores information correlating respective subscribers' interest in respective organizations as further described herein, and includes unique fields for storing the subscriber, organization, referral, time of initial transaction in which each the subscriber initiates an action with respect to each the organization, and a weight value applied to each the organization by respective subscriber for purposes of funds allocation as further described herein. Basket_entry table 514 further includes a unique field for storing subscriber-specific account information with respect to the organization, for example an investment account number where the organization is a mutual fund brokerage with which the subscriber holds the account. Basket_entry table 514 defines each respective correlation as a “primary key” within the ISO SQL: 2003 structure, but further includes “foreign key” references to subscriber table 508, org table 504, and referral table 512. Those skilled in the art will appreciate that the foreign key to referral table 512 is an optional reference and may store a NULL value for interactions not initiated via an affiliated information distribution system.

Transaction table 516 stores information relevant to each action of a subscriber 302 in which the subscriber initiates a transaction that may product a funds transfer into the system, as further described herein, and includes unique fields for storing the subscriber, the referral table 512 entry associated with the initiation, if any, the URL to which the subscriber's client device 310 is directed, and the time at which the referral is initiated. Transaction table 516 defines each respective transaction as a “primary key” within the ISO SQL: 2003 structure, but further includes “foreign key” references to subscriber table 508 and referral table 512. The primary key of the transaction is transferred to the referred-to service for tracking as further defined herein.

Those skilled in the art will appreciate that the foreign key to referral table 512 is an optional reference and may store a NULL value for interactions not initiated via an affiliated information distribution system. Those skilled in the art will further appreciate that the transaction primary key may be incorporated into the URL, HTTP POST data, or by other means, and that the transaction primary key may be used as the “invoice number”, “transaction number”, “affiliate subid”, or other similar tracking code as used by various commonly implemented transaction systems such as affiliate network accounting servers 344, vendor fulfillment systems 346, and financial transaction processing systems 348.

Basket_snapshot table 518 stores a copy of information related to each respective subscriber's basket upon initiation of each respective transaction, and includes unique fields for storing the transaction, organization, referral, the time the organization was first correlated with the subscriber, a weight value as automatically assigned or specified by the subscriber, and a designated flag indicating whether the organization was the designated beneficiary for the transaction as further described herein. As further described herein, each time basket services server 322 creates a new transaction record for a subscriber 302, it creates a record in the basket_snapshot table for each respective record in basket_entry table 514 referencing the subscriber. Basket_snapshot table 518 defines each respective correlation as a “primary key” within the ISO SQL: 2003 structure, but further includes “foreign key” references to transaction table 516, org table 504, and referral table 512. Those skilled in the art will appreciate that the foreign key to referral table 512 is an optional reference and may store a NULL value for interactions not initiated via an affiliated information distribution system, and further that basket_snapshot table 518 serves to record the explicit and complete state of each subscriber's basket elections at the initiation of each respective transaction by the subscriber.

Receipt table 520 stores essential information related to each funds transfer wherein a third party transfers money into a deposit account associated with distributed network accounting system 320, and includes unique fields for storing the subscriber-initiated transaction, payee source, source account from which funds were transferred, deposit account into which funds were deposited, currency amount, time at which the payment is reported, and time at which the funds have been cleared and made available by the receiving financial institution. Receipt table 520 defines each payment as a “primary key” within the ISO SQL: 2003 structure, but further includes a “foreign key” reference to transaction table 516. As further described herein, a receipt record may be created by distributed network accounting system 320 upon first notification that a transaction has been consummated by the respective subscriber, updated with account and financial details when the details are reported to the system at a future time, and further updated when the funds are made available by the receiving financial institution.

Payment table 522 stores essential information related to each respective funds allocation and payment to an affiliate or organization as further described herein, and includes unique fields for storing the affiliate payee, organization payee, deposit account from which funds are paid, payment service by which the funds are transferred, payee account to receive the funds, amount of payment, time the funds are allocated to the payee, and time the funds are distributed for payment. Payment table 522 defines each payment as a “primary key” within the ISO SQL: 2003 structure, but further includes a “foreign key” reference to affiliate table 506 and organization table 504. If a payment is made to an affiliate, the respective table record for the payment will contain a NULL reference to organization table 504; similarly if the payment is made to an organization the respective table record for the payment will contain a NULL reference to affiliate table 506.

Payment_receipts table 524 stores correlations between individual payments and the respective receipts from which each of the payments derive, utilizing a “Many to Many” relationship structure containing unique fields for each pairwise correlation of receipt and payment. Payment_receipts table 524 defines each pairwise relationship as a “primary key” within the ISO SQL: 2003 structure, but further includes “foreign key” reference to receipt table 520 and payment table 522.

Referring to FIG. 6, iterative cascading functional flow block diagram 600 shows the high level operation of one embodiment of the distributed network accounting system of FIG. 3. In various embodiments, approximately six system partitions are provided, the system partitions are organized in a cascading structure, each of which is described in further detail herein. Each of the respective system partitions operates in conjunction with the relational database schema shown in FIGS. 5A-5E through the application programming interface implemented in basket services server 322.

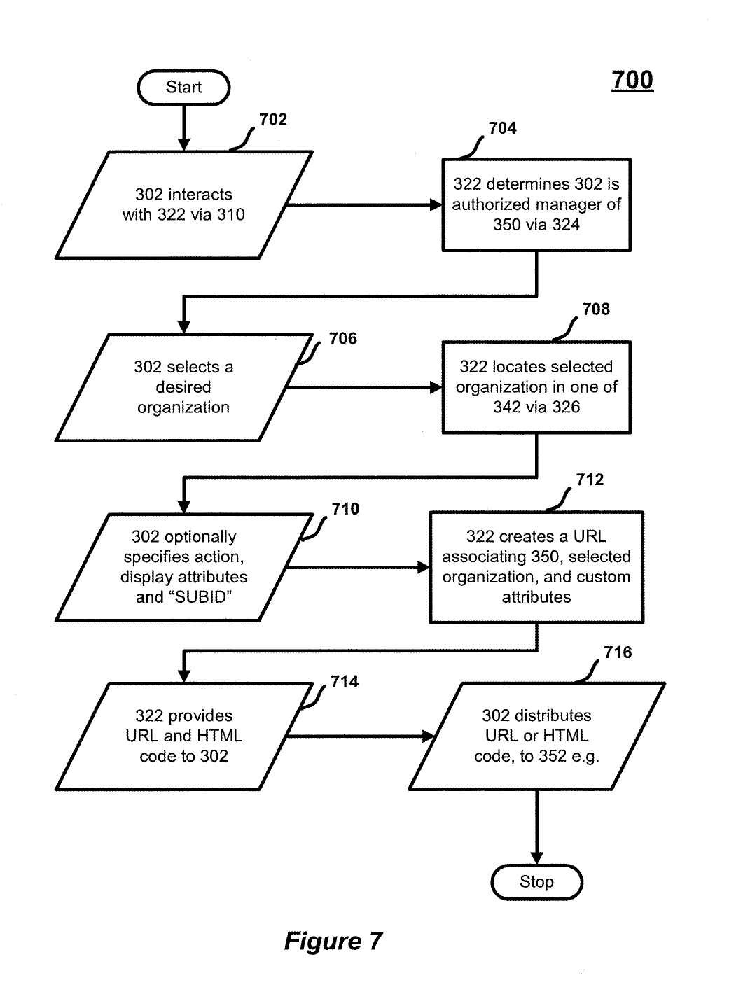

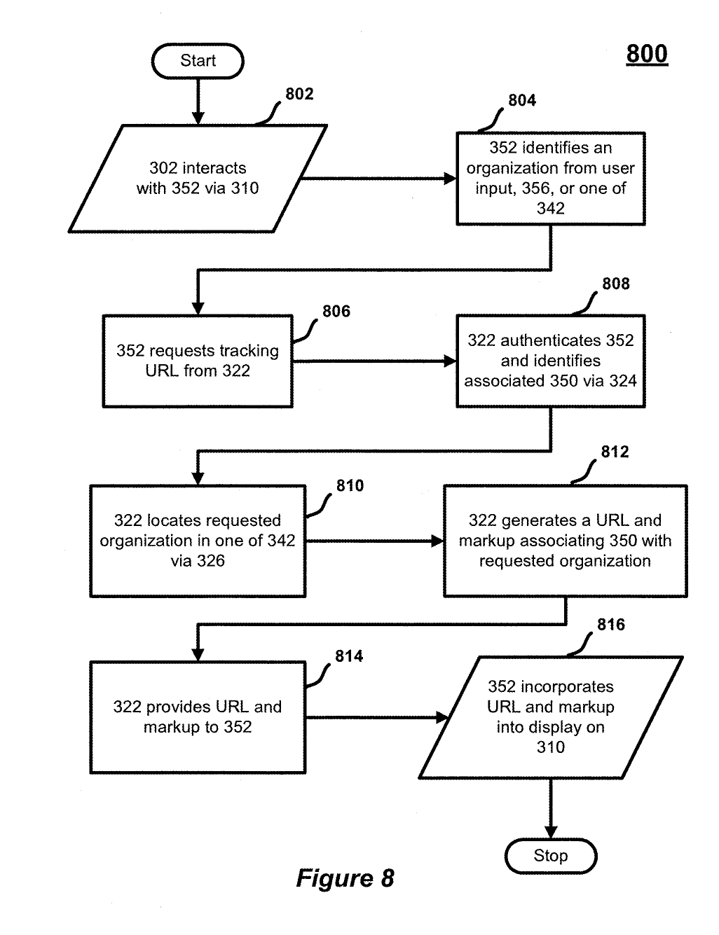

When invoked, in one embodiment, system module 602 provides system controls for creating URLs and hyperlinks associating each respective affiliated information distribution system 520 with respective organizations as known to organization data server 326. The detailed operation of module 602 is described further in conjunction with FIGS. 7 and 8.

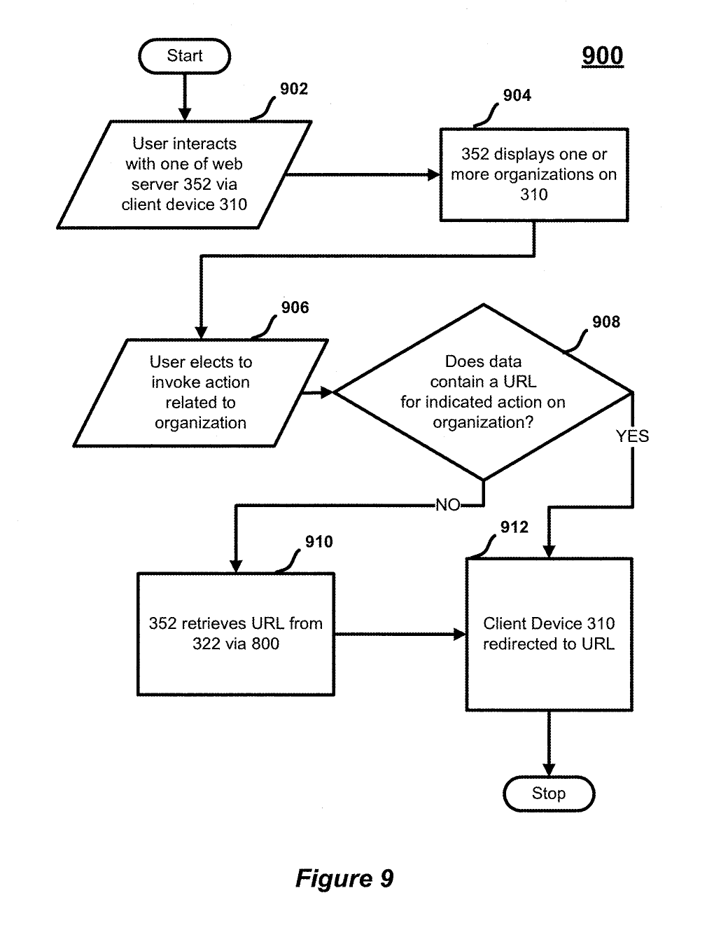

In one embodiment, system module 604 provides system controls wherein a subscriber interacts with an affiliate and initiates a transaction with the distributed network accounting system 320. The detailed operation of module 602 is described further in conjunction with FIGS. 9, 10, and 11.

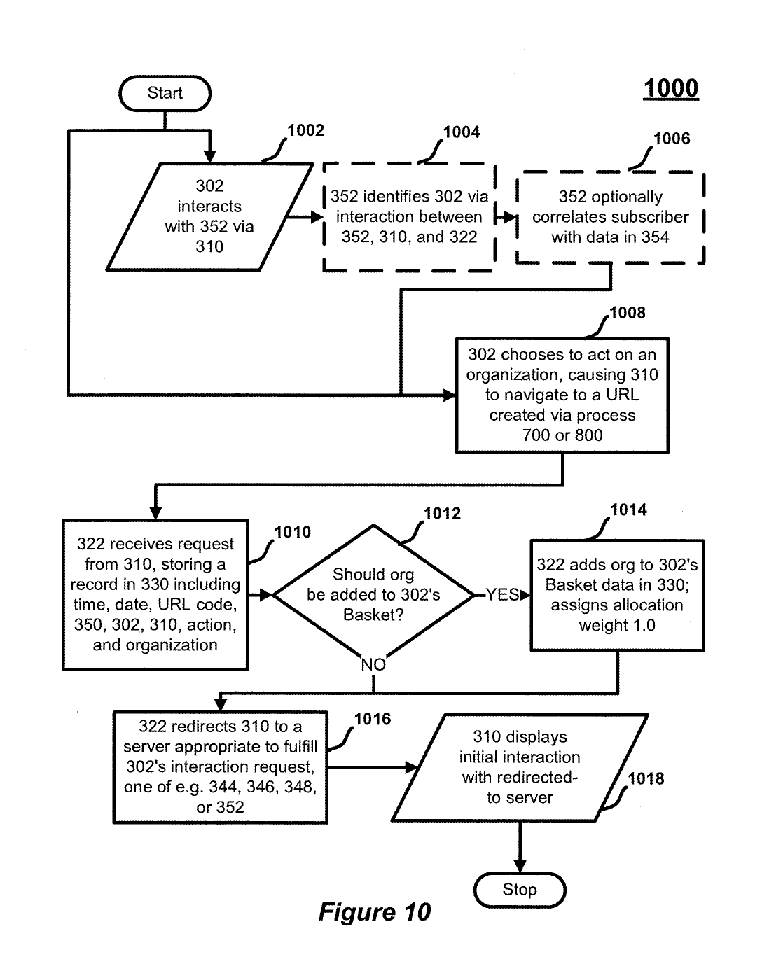

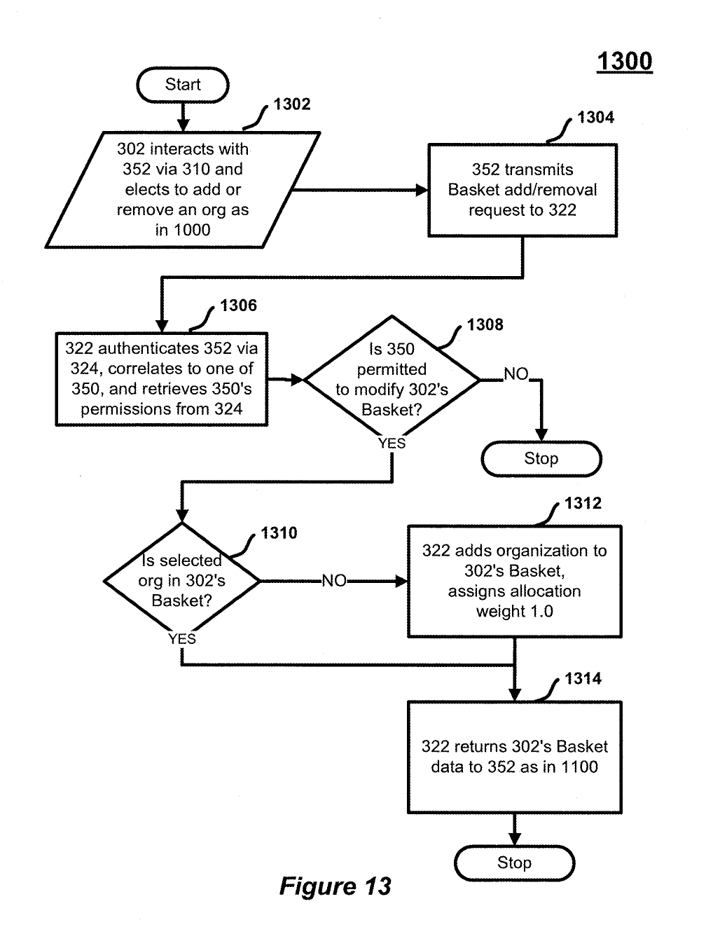

In one embodiment, system module 606 provides system controls wherein a subscriber selects or designates one or more organizations to be associated with the subscriber's basket and fund allocations. The detailed operation of module 606 is described further in conjunction with FIGS. 10 and 13.

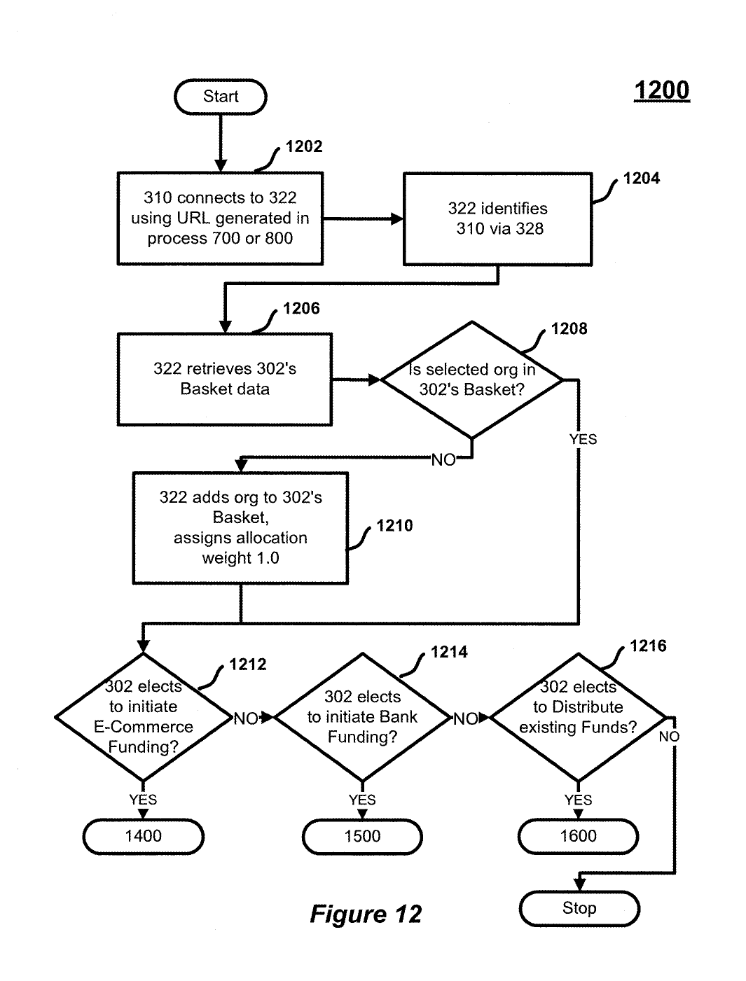

In one embodiment, system module 608 provides system controls wherein a subscriber initiates a transaction causing funds to be deposited into an account associated with distributed network accounting system 320. The detailed operation of module 608 is described further in conjunction with FIGS. 12, 14, and 15.

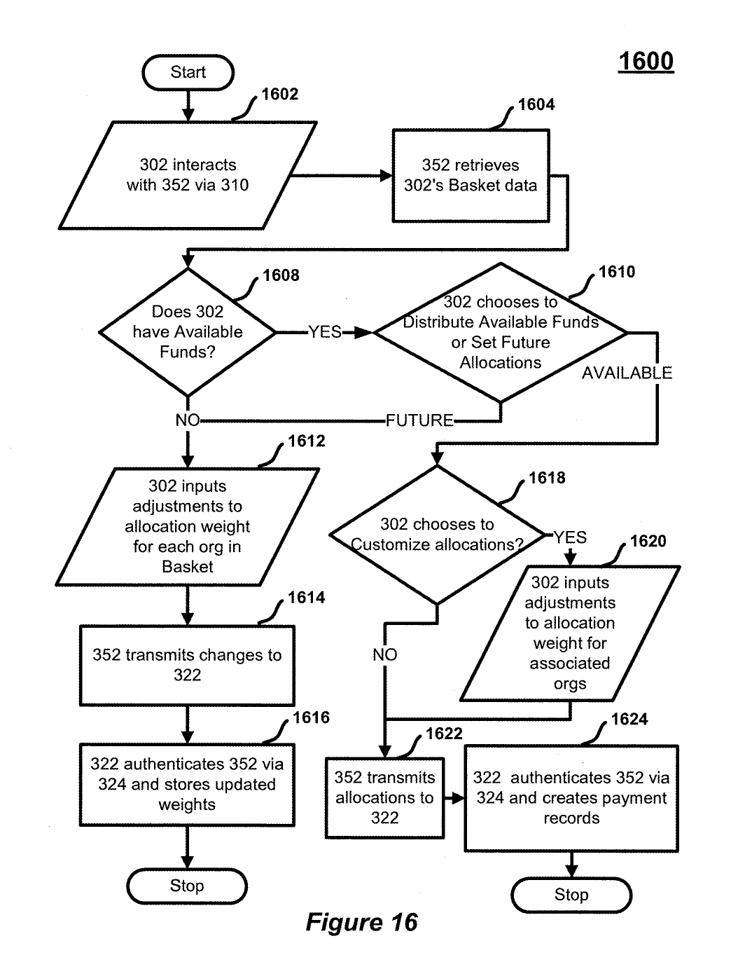

In one embodiment, system module 610 provides system controls wherein a subscriber specifies relative weights and preferences according to which funds available to the subscriber will be allocated among the subscriber's selected or designated organizations. The detailed operation of module 610 is described further in conjunction with FIG. 16.

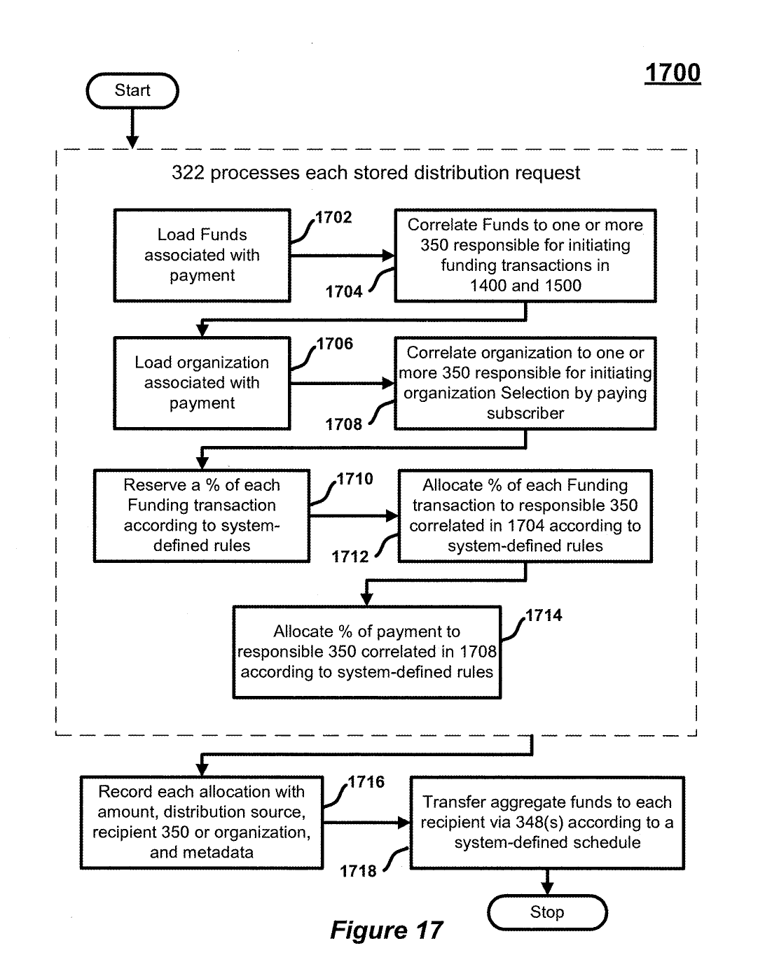

In one embodiment, system module 612 provides system controls wherein the basket services server allocates payments to the various affiliates and organizations associated with activities performed by, and specifications provided by, each respective subscriber. The detailed operation of module 612 is described further in conjunction with FIG. 17.

In one embodiment, the system returns to system module 604 upon completion of the tasks in system modules 606, 608, 610, and 612, to repeatedly provide services to subscribers 302.

FIG. 7 shows one aspect of a system control and data flow 700 associated with affiliates creating tracking URLs. An affiliate operator 302 interacts with basket services server 322 using a client device 310 in process step 702. In one embodiment, basket services server 322 authenticates operator 302 and identifies the operator's associated information distribution system using affiliate authentication server 324 in process step 704. Operator 302 searches for and selects an organization in process step 706.

In one embodiment, basket services server 322 retrieves profile data for the selected organization from organization data server 326, which in turn retrieves the data from one of organization database systems 342, in process step 708. Those skilled in the art will appreciate that organization data server 326 operates as a meta-search engine by providing a single API to basket services server 322 and transparently executing searches against multiple organization database systems 342.

Operator 302 optionally specifies the action subscribers invoking this link are initiating, a custom tracking code, and/or display attributes in process step 710. In one embodiment, basket services server 322 generates a URL containing an identifier unique to information distribution system 350, an identifier unique to the selected organization, the subscriber action to perform, if specified, and the operator-provided tracking code, if specified, and further generates HTML markup suitable for generating a custom user interface element with the attributes and incorporating specified display attributes, examples of which are element size and color, in process step 712. Basket services server displays the generated URL and HTML markup to the operator in process step 714. Operator then causes the displayed URL and/or HTML markup to be distributed to existing and prospective subscribers in process step 716.

Those skilled in the art will appreciate that the distribution may be accomplished by adding the URL and markup to a content management system incorporated into respective web server 352, by publishing the URL or markup to any of a variety of electronic communications systems including e-mail, by transmitting the URL or markup to an application operating on any number of client devices 310, or by communicating the URL, in it's entirety or in multiple component parts, to individuals who enter the URL or components into a client device 310 by way of user input devices such as a keyboard. These specific descriptions of data, display, and transmission process are exemplary and not limiting with respect to the present disclosure; many additional display attributes and methods of communicating generated URLs and markup to subscribers are contemplated.

FIG. 8 shows one aspect of a system control and data flow 800 associated with a web server 352 incorporating a tracking URL into displayed content when a subscriber 302 interacts with respective information distribution system 350. A subscriber 302 interacts with web server 352 using a client device 310 in process step 802. In one embodiment, web server 352 identifies an organization of interest to the subscriber based on user input (a search engine, for example), from the respective information distribution system 350's organization database, or from one of organization database systems 342 in process step 804. In one embodiment, web server 352 establishes a connection to basket services server 322 and transmits authentication credentials, a unique identifier associated with the organization, such as the organization's assigned tax id or legal name, an optional subscriber action, and an optional custom tracking code in process step 806. Upon receiving a request from web server 352, in one embodiment, basket services server 322 authenticates the request and retrieves affiliate details for the respective information distribution system 350 from affiliate authentication server 324 in process step 808.

In one embodiment, basket services server 322 retrieves profile data for the requested organization from organization data server 326, which in turn retrieves the data from one of organization database systems 342, in process step 810. Basket services server 322 generates a URL and HTML markup containing an identifier unique to information distribution system 350, an identifier unique to the requested organization, the subscriber action to perform, if specified, and the operator-provided tracking code, if specified, in process step 812. Basket services server 322 transmits the generated URL, markup, and retrieved organization profile data to web server 352 in process step 814. Web server 352 incorporates the received URL, markup, and organization profile data into the user interface displayed on the client device 310 in process step 816.

FIG. 9 shows one aspect of a system control and data flow 900 associated with one embodiment of a web server 352 directing a subscriber 302 to the authoritative location for information pertaining to an identified organization. A subscriber 302 interacts with web server 352 using a client device 310 in process step 902. In one embodiment, web server 352 presents one or more organizations to the subscriber via a list, searchable database, or other user interface in process step 904. The subscriber selects an organization and initiates a request to take an action with respect to the organization in process step 906. In one embodiment, web server 352 determines whether its local data store contains a URL appropriate for the action upon the organization in process step 908. If it does, control transfers to process step 912, otherwise control continues to process step 910. In one embodiment, web server 352 retrieves a URL associated with the organization and the action from basket services server 322 via process 800 in process step 910. Client device 310 is directed to the URL in process step 912.

During process steps 904 and 906, web server 352 may present hypermedia references on client device 310 that refer to impression tracking URLs hosted by one embodiment of basket services server 322 as previously described herein. When client device 310 requests the URLs from basket services server 322, basket services server identifies or creates a new data record for the subscriber in subscriber table 508 contained on database management server 330 as further described herein, and stores information related to the referring affiliate, subject organization, client device, subscriber, and request in impression table 510 on database management server 330.

FIG. 10 shows one aspect of a system control and data flow 1000 associated with a subscriber initiating an action with respect to an identified organization, wherein the initiation may begin by interacting with an information distribution system via process step 1002 or may begin by the subscriber interacting with, or inputting via input device, a URL communicated via electronic messaging service or analog dissemination as previously described herein via process step 1008. A subscriber 302 interacts with one embodiment of a web server 352 using a client device 310 in process step 1002. In one embodiment, web server 352 optionally identifies subscriber 302 via a three-step handshake with one embodiment of basket services server 322 in process step 1004.

Step 1 of the handshake is initiated by web server 352 by generating a URL associated with basket services server 322 that contains a token cryptographically signed by web server 352 with a secret known to affiliate authentication server 324 using, for example, the Pretty Good Privacy (PGP) message signature algorithm. Upon establishing a connection with client device 310, in one embodiment, basket services server 322 extracts the signed token from the request URL and authenticates the signature by communicating with affiliate authentication server 324.

Step 2 of the handshake is initiated upon successful authentication of the signed token by basket services server 322, which identifies the connecting subscriber by, for example, reading an identifier cookie from the HTTP request established by client device 310 and correlating the identifier value to a record in subscriber table 508 managed by user registration server 328. If user registration server 328 cannot correlate an existing subscriber to the request, it creates a new subscriber record in subscriber table 508 and provides the new subscriber record's identifier to basket services server 322, which stores an identifier cookie on client device 310 via HTTP response. In one embodiment, basket services server 322 then generates a unique handshake code and stores the code associated with the identified subscriber in local storage on server 322. In one embodiment, basket services server then generates a URL associated with web server 352 that contains the handshake code and redirects client device 310 to the URL.

Step 3 of the handshake is initiated when the client device connects to web server 352 utilizing the URL containing the handshake code. Upon establishing a connection with client device 310, in one embodiment, web server 352 recognizes the presence of the handshake code in the request URL. In one embodiment, web server 352 connects to the basket services server utilizing a secure connection, such as HTTPS, and transmits a token exchange request, including the handshake code and a cryptographic signature of the handshake code. In one embodiment, basket services server 322 authenticates the signature via affiliate authentication server 324, retrieves the subscriber data associated with the handshake code, and transmits the subscriber data to web server 352 via the secure connection. In one embodiment, web server 352 stores the received subscriber data and associates it with the client device 310 using, for example, an HTTP session cookie.

Those skilled in the art will appreciate that the above-described handshake is derived from various secure third-party identity frameworks such as OAUTH and OAUTH2 specifications that may be found at http://oauth.net/ and implementations such as Facebook Connect.

In one embodiment, web server 352 optionally correlates subscriber 302 with a web-site-specific membership account by querying respective member database 354 for profile information correlated to retrieved subscriber data in process step 1006.

Subscriber 302 chooses to initiate an action with respect to an identified organization, as previously described herein, and the subscriber's respective client device connects to a URL generated via process 700 or 800 in process step 1008. Upon establishing a connection with client device 310, in one embodiment, basket services server 322 identifies or creates a new data record for the subscriber as previously described herein, and stores information related to the requested action, referring affiliate, organization, client device, subscriber, and request to referral table 512 on database management server 330 in process step 1010.

In one embodiment, basket services server 322 determines whether the action invoked by subscriber 302 should cause the subject organization to be associated with the subscriber's basket in process step 1012, and transfers control to process step 1016 if it should not. In one embodiment, basket services server 322 determines whether a record exists in basket_entry table 514 for the subscriber and the organization, and creates a record if it does not, storing the subscriber, organization, referral, time, and subscriber-specific account data if provided in basket_entry table 514 on database server 330 in process step 1014. In one embodiment, basket services server 322 generates a URL appropriate for fulfilling the indicated action on the organization and redirects client device 310 to the URL in process step 1016. Client device 310 connects to the generated URL in process step 1018 and subscriber continues with the action.

Those skilled in the art will appreciate that, in one embodiment, basket services server 322 may use a combination of data retrieved from various servers, configuration data, and programmed logic to generate an appropriate URL for each respective action on each respective organization. By way of example, a request to view detailed profile information about an organization may cause one embodiment of basket services server 322 to retrieve profile data from organization data server 326 as previously described herein, locate the canonical profile URL for the organization in the data, and redirect to the profile URL. Further, a request to donate to the organization may cause one embodiment of basket services server 322 to create a transaction record as further described herein, select one of financial transaction processing systems 348, retrieve the URL for the system 348 from configuration data, insert the transaction identifier into the URL, and redirect to the generated URL. Those skilled in the art will appreciate that these methods are provided by way of example and not limitation, and many possible actions may be implemented in the same manner, as configured and programmed into distributed network accounting system 320.

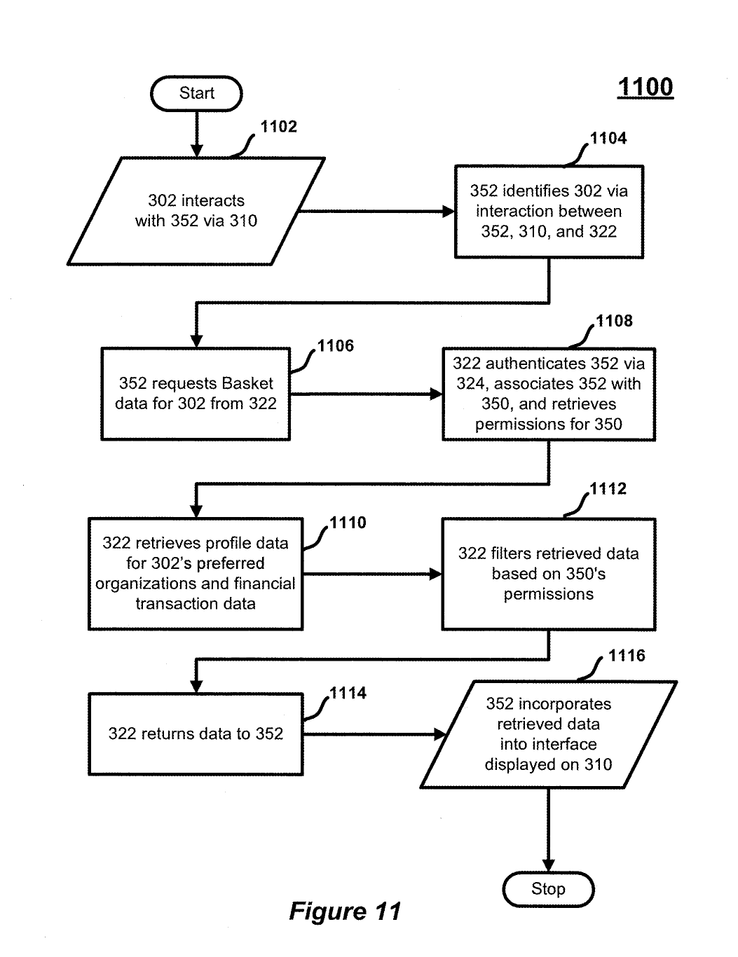

FIG. 11 shows one aspect of a system control and data flow 1100 associated with a subscriber 302 accessing a web server 352 wherein, in one embodiment, web server 352 retrieves organization data associated with subscriber 302's basket from basket services server 322 and displays the data to subscriber 302. A subscriber 302 interacts with a web server 352 using a client device 310 in process step 1102. In one embodiment, web server 352 identifies subscriber 302 and determines subscriber 302's identifier as previously described herein in process step 1104. In one embodiment, web server 352 transmits an API request to basket services server 322 containing authentication credentials and subscriber 302's identifier in process step 1106. Upon establishing a connection with web server 352, in one embodiment, basket services server 322 authenticates the provided credentials with affiliate authentication server 324 and retrieves the permissions granted to information distribution system 350 associated with web server 352 in process step 1108.

Those skilled in the art will appreciate that affiliate authentication server 324 functions as a “directory services server”, examples of which are lightweight directory access protocol (LDAP) and Microsoft active directory servers. Those skilled in the art will further appreciate that the directory services servers provide APIs allowing one server to authenticate credentials provided by a second server and store fine-grained descriptive permissions associated with the authenticated server, such as permission to read and/or write various classifications of data.

In one embodiment, basket services server 322 locates the organizations listed in basket_entry table 514 correlated to the provided subscriber identifier and retrieves profile data from organization data server 326 for the organizations, and retrieves summary financial data for the subscriber from receipt table 520 and payment table 522 in process step 1110. In one embodiment, basket services server 322 filters the retrieved financial data, organization list and respective organization profile data according to permissions granted to the information distribution system 350 in process step 1112. Those skilled in the art will appreciate that the filtering may remove multiple subsets of detailed and/or summary financial data, remove organizations and respective profile data from the organization list entirely, may remove unique fields of profile data from all retrieved organization profiles, or may remove unique fields of profile data from select organizations, according to the specific configuration and matching rules present in the permissions, and that the rules and permissions may be defined across all subscribers and/or any expressible combination of subsets of subscribers as further defined by the configuration and rules.

In one embodiment, basket services server 322 transmits the permitted list of organizations and respective profile data to requesting web server 352 in process step 1114. Web server 352 incorporates the retrieved data, or a subset thereof, into the user interface displayed on the subscriber 302's client device 310 in process step 1116. Those skilled in the art will appreciate that the specific data retrieved, filtered, and displayed may be expanded to include subscriber profile data and additional data such as advertisements, promotions, and suggestions for additional organizations and other content or services, as implemented within basket services server 322, and that the above disclosed process and data are provided by way of example and not limitation.

FIG. 12 shows one aspect of a system control and data flow 1200 associated with a subscriber 302 electing to add an organization to subscriber 302's basket and optionally invoke a further action with respect to the organization. A subscriber 302 directs a client device 310 to connect to a URL generated and provided to the subscriber via process 700 or 800 in process step 1202. Upon establishing a connection with client device 310, in one embodiment, basket services server 322 identifies the client device 310's operating subscriber 302 via user registration server 328 as previously described herein in process step 1204. In one embodiment, basket services server 322 retrieves organizations associated with the subscriber 302 from basket_entry table 514 in process step 1206. Basket services server identifies the organization referenced in the request URL and determines whether the organization is currently associated with the subscriber's basket in process step 1208 and transfers control to process step 1212 if the organization is so associated. In one embodiment, basket services server 322 adds the identified organization to the subscriber's basket as further described herein and assigns allocation weight of 1.0 in process step 1210.

In one embodiment, basket services server 322 examines the request URL to determine if the URL encodes an action that indicates subscriber initiates funding via transaction with one of vendor fulfillment systems 346 and redirects client to initiate process 1400 if so in process step 1212. In one embodiment, basket services server 322 examines the request URL to determine if the URL encodes an action that indicates subscriber initiates funding via funds transfer with one of financial transaction processing systems 348 and redirects client to initiate process 1500 if so in process step 1214. In one embodiment, basket services server 322 examines the request URL to determine if the URL encodes an action that indicates subscriber initiates allocation and distribution of available funds and redirects client to initiate process 1600 if so in process step 1216.

FIG. 13 shows one aspect of a system control and data flow 1300 associated with a subscriber 302 electing to add an organization to subscriber 302's basket, where the election is executed on an affiliated information distribution system 350. A subscriber 302 interacts with a web server 352 using a client device 310, selects an organization, and elects to add the organization to the subscriber's basket, such as described in process 1000, in process step 1302. In one embodiment, web server 352 transmits an API request to basket services server 322 providing authentication credentials, the subscriber identifier, and the organization identifier in process step 1304. In one embodiment, basket services server 322 authenticates the API request and retrieves authenticated information distribution system 350's permissions as previously described herein in process step 1306.

In one embodiment, basket services server 322 examines the permissions to determine whether the information distribution system 350 is permitted to add or remove the organization from the subscriber's basket as required to fulfill the API request in process step 1308, and rejects the request if permission is not granted. In one embodiment, basket services server 322 determines whether the organization is associated with the subscriber's basket in process step 1310, and transfers control to process step 1314 if the organization is already so associated. In one embodiment, basket services server 322 associates the organization with the subscriber's basket as previously described herein and assigns allocation weight 1.0 in process step 1312. Basket services server 322 collects the subscriber's associated organizations and organization profile data as described in process 1100 and returns the collected information to web server 352 in process step 1314.

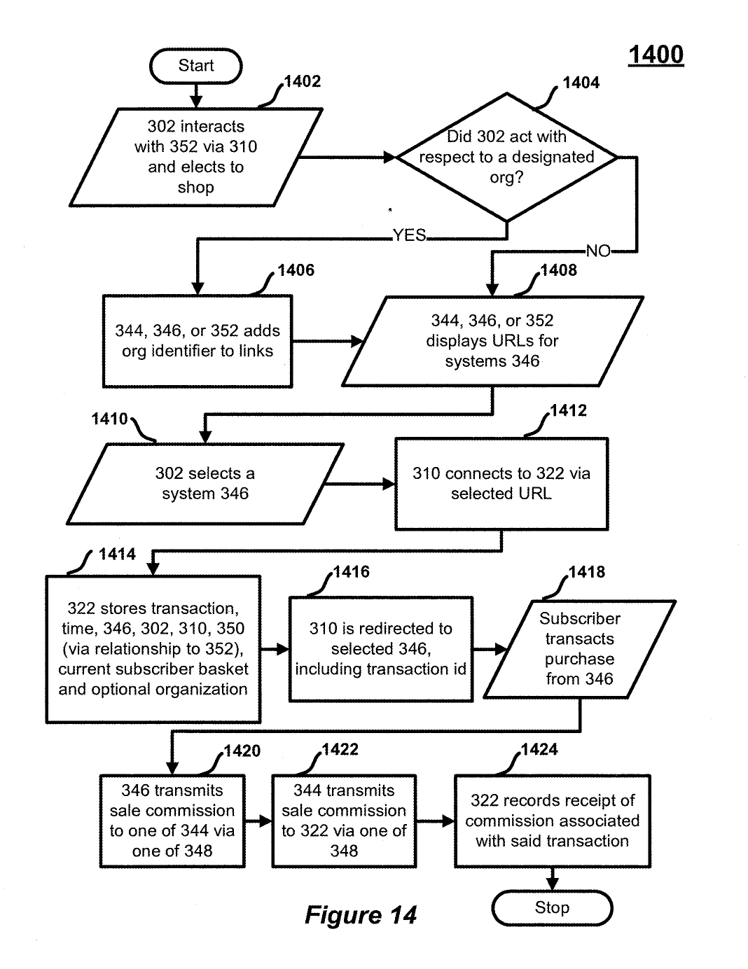

FIG. 14 shows one aspect of a system control and data flow 1400 associated with a subscriber 302 electing to perform a transaction with one of vendor fulfillment systems 346 and allocate a portion of the transaction to one embodiment of distributed network accounting system 320. A subscriber 302 interacts with a web server 352 using a client device 310 and elects to initiate a merchant transaction via, for example, process 1200 in process step 1402. System 344, 346, or 352, as designated by destination URL in the previous step, determines whether subscriber initiated action so as to designate all proceeds to a specific organization in process step 1404, and transfers control to process step 1408 if not. The system 344, 346, or 352 incorporates a unique identifier of the designated organization into tracking URLs for each known vendor fulfillment system 346 to be displayed in process step 1406. The system 344, 346, or 352 displays a list of one or more known vendor fulfillment systems 346 with their respective tracking URLs in process step 1408. Subscriber 302 selects one of the vendor fulfillment systems 346 in process step 1410. The subscriber's client device 310 connects to basket services server 322 using the tracking URL associated with the selected system 346 in process step 1412.

Upon establishing a connection with client device 310, in one embodiment, basket services server 322 creates a referral table 512 record as previously described herein, generates a URL appropriate for the vendor fulfillment system 346 as specified in the request URL, and creates a transaction table 516 record indicating the subscriber, referral table 512 record, generated URL, and time, and further retrieves all records from basket_entry table 514 associated with the subscriber and creates records in basket_snapshot table 518 correlating to each the record from basket_entry table 514 in process step 1414, marking basket_snapshot table 518 records as designated if each the record's respective organization is designated as sole recipient for the transaction.

In one embodiment, basket services server 322 incorporates the transaction record's primary key into the generated URL and redirects connected client device 310 to the URL in process step 1416. The subscriber 302 interacts with the selected vendor fulfillment system 346 to enact a purchase of goods or services in process step 1418.

In one embodiment, vendor fulfillment system 346 transmits a report of the purchase, including transaction identifier, to one of affiliate accounting systems 344 and initiates a commission funds transfer to system 344 via one of financial transaction processing systems 348 according to payment rules defined between respective vendor fulfillment systems and affiliate accounting systems in process step 1420. Upon receipt of report, the affiliate accounting system 344 transmits a report of the purchase, including transaction identifier, and commission to basket services server 322, and upon receipt of funds, in one embodiment, affiliate accounting system 344 initiates a commission funds transfer to a deposit account associated with the distributed network accounting system 320 via one of financial transaction processing systems 348 in process step 1422. In one embodiment, basket services server 322 identifies each so-reported transaction identifier and records the reported commission value in receipt table 520, associating each receipt record with the respective transaction record, and records receipt and clearance of funds into the deposit account in process step 1424.

Those skilled in the art will appreciate that the reporting described in process steps 1420 and 1422 is the process implemented by merchant affiliate networks such as Commission Junction, that each transaction report and respective funds transfer may occur at separate times, and that each funds transfer may comprise commissions from multiple subscriber-vendor transactions, in which case the funds transfer will be associated with multiple transaction identifiers and identify each unique transaction with it's respective commission value. Those skilled in the arty will further appreciate that the described process for purchasing is exemplary and that additional processes for tracking and generating commissions are contemplated, such as inducing subscribers to register their payment or merchant loyalty card number and enacting commission auditing and billing via card processing providers. Such systems are commonly implemented and available from providers such as RewardsNOW's ShoppingFLING service at http://vvww.rewardsnow.com/.

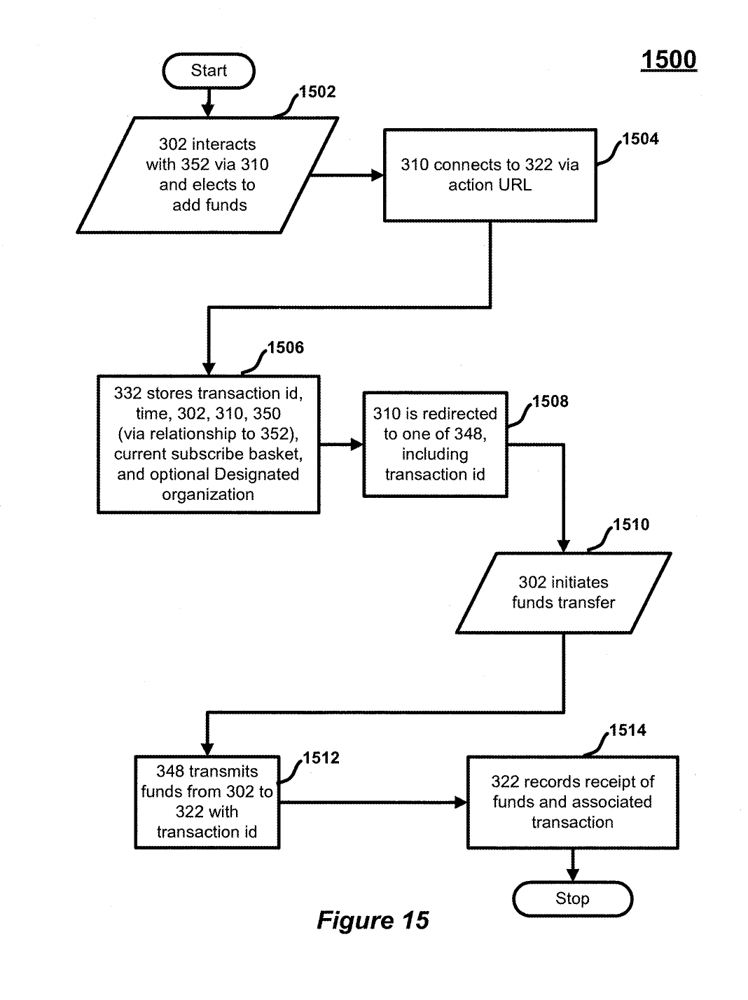

FIG. 15 shows one aspect of a system control and data flow 1500 associated with a subscriber 302 electing to transfer funds into one embodiment of distributed network accounting system 320. A subscriber 302 interacts with a web server 352 using a client device 310 and elects to initiate a funds transfer via, for example, process 1200 in process step 1502. The client device 310 connects to basket services server 322 using a URL associated with the subscriber action created via, for example, process 700 or 800, in process step 1504. Upon establishing a connection with client device 310, in one embodiment, basket services server 322 records the referral and creates a transaction record in process step 1506, as previously described herein.

Client device 310 is redirected to one of financial transaction processing systems 348 in process step 1508. Subscriber 302 performs necessary authentication, data entry, and authorization to initiate a funds transfer via the financial transaction processing system 348 in process step 1510. The financial transaction processing system 348 enacts a transfer between financial institutions and accounts by, for example, ACH, to effect a funds transfer from subscriber 302 to a deposit account of distributed network accounting system 320 and notifies basket services server 322 of the completed transaction via, for example, API request or client device 310 redirection to basket services server 322, in process step 1512. Upon notification of funds transfer initiation by financial transaction processing system 348, in one embodiment, basket services server 322 creates a receipt table 520 record associated with the transaction, and updates the receipt record when the funds transfer clears in process step 1514, as previously described herein.

FIG. 16 shows one aspect of a system control and data flow 1600 associated with a subscriber 302 electing to set allocations and/or distribute funds to select organizations. A subscriber 302 interacts with a web server 352 using a client device 310 in process step 1602. In one embodiment, in one embodiment, web server 352 retrieves the subscriber 302's financial and organization election data from basket services server 322 in process step 1604, as previously described herein. In one embodiment, web server 352 determines whether the subscriber 302 has available funds for distribution in process step 1608 and, if not, transfers control to process step 1612. In one embodiment, web server 352 presents a user interface to the subscriber 302 permitting the subscriber to choose between allocating and distributing currently available funds or setting future allocation preferences in process step 1610, and transfers control to process step 1618 if subscriber elects to distribute funds or process step 1612 if subscriber elects to specify future allocation preferences.

The subscriber 302 interacts with web server 352 via a user interface displaying the currently assigned weights for all organizations associated with the subscriber's basket and optionally modifies one or more of the weights in process step 1612. In one embodiment, web server 352 transmits changes specified by the subscriber to basket services server 322 via API request in process step 1614. Upon establishing a connection with web server 352, in one embodiment, basket services server 322 authenticates the API request and determines whether the web server 352's associated information distribution system 350 is permitted to modify the subscriber's allocation weights and, if permitted, updates the weight values stored in basket_entry table 514 for the subscriber to reflect the updated weights for respective organizations in process step 1616.

Subscriber 302 interacts with web server 352 and is indicates whether the subscriber wishes to modify the stored allocation weights for the subscriber's basket organizations in process step 1618, and control transfers to process step 1622 if not. Subscriber interacts with web server 352 to view and update the stored allocation weights, and elect whether the modifications should be stored to subscriber's basket_entry table records or only apply to the current distribution, in process step 1620. Web server 352 transmits the distribution request for the subscriber, and optional allocation modifications, to basket services server 322 in process step 1622.

Upon establishing a connection with web server 352, in one embodiment, basket services server 322 authenticates the API request and determines whether the web server 352's associated information distribution system 350 is permitted to modify allocation weights and/or initiate fund distributions in process step 1624. In one embodiment, basket services server 322 further retrieves all receipt table 520 and payment table 522 records associated with the subscriber, and retrieves relationships between respective receipt and payment records from payment_receipts table 524. In one embodiment, basket services server 322 correlates the payment records to the receipt records and calculates, for each receipt, the aggregate value of payments issued against the receipt. Basket services server discards each receipt record for which the full receipt value has already been issued via one or more payment records. The aggregate value of the remaining receipt records, minus the aggregate value of the receipt records' respective payment records, provides the available funds for the current distribution. Basket services server then computes the portion of the available funds to distribute to each organization associated with the subscriber's basket by multiplying the total available funds by each organization's assigned weight and dividing the result by the sum of all weights in the subscriber's basket. In one embodiment, basket services server 322 creates a record in payment table 522 for each the organization with the respective computed payment amount and associates the record with the remaining receipt records via entries in payment_receipts table 524. Upon completion of this process, the remaining receipt records now have payment records associated with them wherein the aggregate value of the payment records equal the value of the respective receipt records such that the receipt records will be discarded from future invocations of process step 1624.

In one embodiment, basket services server 322 further stores alterations to weight values in the subscriber's basket_entry table in process step 1624 if information distribution system 350 is permitted to modify allocations, the subscriber provided weight modifications, and subscriber indicated the modification should be stored for future use via process step 1620.

FIG. 17 shows one aspect of a system control and data flow 1700 associated with distributed network accounting system 320 processing records in payment table 522. Basket services server 322 performs a 7-step process on each record in payment table 522 that has a NULL value for the paid_at field, as follows.

In one embodiment, basket services server 322 reads the amount of the first the payment record in process step 1702. The payment is correlated to zero or more information distribution systems 350 via traversal of foreign key relationships through payment_receipts table 524, receipt table 520, transaction table 516, basket_snapshot table 518, and referral table 512 in process step 1704, providing the information distribution systems 350 responsible for inducing subscriber to transfer the funds into distributed network accounting system 320.

The organization associated with the payment record is determined in process step 1706. The organization is correlated to zero or more information distribution systems 350 via traversal of foreign key relationships through basket_snapshot table 518 and referral table 512 in process step 1708, providing the information distribution systems 350 responsible for inducing subscriber to add the organization to the subscriber's basket.

A system-configured percentage of the payment amount is subtracted from the payment amount and designated as a commission in process step 1710. The commission is divided according to system-configured rules among information distribution systems 350 identified via process step 1704 in process step 1712. If zero systems 350 were so identified, the commission amount is added back to the payment amount. A second system-configured percentage of the payment amount is further subtracted and divided according to system-configured rules among information distribution systems 350 identified via process step 1708, if any, in process step 1714.

The resulting allocations to information distribution systems 350 and organizations computed in the 7-step process are accumulated in local storage and correlated to respective payment table 522 records and tax and financial transfer data for each respective payee by basket services server 322 in process step 1716. Basket services server 322 computes the aggregate payment value due to each payee and initiates funds transfers from one or more deposit accounts to each respective payee via one or more financial transaction processing systems 348, and updates associated payment table 322 records with the time that payment is initiated in process step 1718.

The techniques described herein may be implemented in hardware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, desktop computers, any of a number of server types or other electronic units designed to perform the functions described herein, or a combination thereof.

For software implementations, the techniques described herein may be implemented with modules (e.g., procedures, functions, and so on) that perform the functions described herein. The software codes may be stored in a memory unit and executed by processors, controllers, computers and/or servers described herein. The memory unit may be implemented within the processor or external to the processor, in which case it can be communicatively coupled to the processor via various means as is known in the art.

The description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the claims. Thus, the scope of the claims is not intended to be limited to the embodiments shown herein but is to be accorded the widest scope consistent with the principles and novel features disclosed herein.

Even though the various aspects and embodiments described above with reference to an example according to the accompanying drawings, it is clear that such aspects and embodiments are not restricted thereto and can be modified in several ways within the scope of the appended claims.

What is claimed is:

1. A method for associating subscribing users with multiple beneficiary recipients in a distributed transactions processing system, the method comprising:
storing information for a subscribing user and about affiliate organizations in a distributed network transactions processing system data storage, wherein the stored information comprises which beneficiary recipients the subscribing user has selected to be associated with and financial institutions the subscribing user has selected as sources of funding;
receiving by the distributed network transactions processing system requests from the affiliate organizations to look up subscribing users, finding the requested users in the data storage, and returning a lookup response for each subscribing user that contains information about the beneficiary recipients associated with the subscribing user;
transmitting by the distributed network transactions processing system a basket interface component that is transmitted with a look up response to an affiliate organization, wherein the basket interface component is embedded into a user interface of the affiliate organization, and the basket interface component displays to a subscribing user the beneficiary recipients the subscribing user previously selected as recipients of funds of the subscribing user;
receiving by the distributed network transactions processing system input from an affiliate organization user interface that captures subscribing user input to the affiliate organization user interface that indicates the subscribing user is adding or removing a beneficiary recipient to the basket interface component, wherein the distributed network transactions processing system records in its data storage a new association, or deletes an existing association, between the subscribing user and the beneficiary recipient and transmits information back to the affiliate organization user interface to update the appearance of the basket interface component to reflect the addition or removal of a beneficiary recipient; and
receiving by the distributed network transactions processing system input from the basket interface component indicating that a subscribing user interacting with the user interface of an affiliate organization wishes to donate funds to one or more beneficiary recipients, wherein the distributed network transactions processing system communicates to the subscribing user the financial institutions that the subscribing user has registered with the distributed network transactions processing system, connects the subscribing user with a financial institution that the subscribing user selects so that the subscribing user can initiate a transfer of funds from the financial institution to the distributed network transactions processing system, and then transfer those funds from the distributed network transactions processing system to the one or more beneficiary recipient selected by the subscribing user.

2. The method of claim 1, further comprising:
tracking by the distributed network transactions processing system funds available to each subscribing user;
providing by the distributed network transactions processing system the amount of funds available as part of the basket interface component, and that amount is displayed to the user through the basket interface component as it is embedded in an affiliate organization user interface;
receiving by the distributed network transactions processing system input from the basket interface component indicating that a subscribing user interacting with the user interface of an affiliate website wishes to add funds, wherein the distributed network transactions processing system communicates to the subscribing user the financial institutions that the subscribing user has registered with the distributed network accounting system, connects the subscribing user with a financial institution that the subscribing user selects so that the subscribing user can initiate a transfer of funds from the financial institution to the distributed network transactions processing system;
receiving by the distributed network transactions processing system input from the basket interface component indicated that a subscribing user interacting with the user interface of an affiliate website wishes to distribute funds to one or more beneficiary recipients, wherein the distributed network transactions processing system transfers funds to the one or more beneficiary recipients designated by the subscribing user.

3. The method of claim 1, wherein the distributed network transactions processing system comprises a basket services system, the method further comprising:
receiving by the distributed network transactions processing system incoming requests;
authenticating by an affiliate authentication system accesses by the affiliate organizations that are received through the basket services system;
storing in an organization database information about beneficiary recipients that have registered with the distributed network transactions processing system;
authenticating by a user authentication system access by subscribing users that are received through the basket services system; and
storing in a database management system information for the subscribing users and conducting searches to find subscribing users information when requests for such information is received through the basket services software.

4. The method of claim 1, further comprising storing by the distributed network transactions processing system for each subscribing user a weight for each beneficiary recipient such that the subscribing user can distribute funds among beneficiary recipients unequally.

5. The method of claim 1, further comprising:
associating by the distributed network transactions processing system beneficiary recipients with one or more categories;
displaying the one or more categories to the subscribing user through the basket component interface.

6. The method of claim 1, further comprising:
receiving by the distributed network transactions processing system an input through the basket interface component, the input indicating that the subscribing user wishes to get more information about the contents of the basket;
responding by the distributed network transactions processing system by transmitting information to the basket interface component to update the display with information about each beneficiary recipient associated with the subscribing user, including information to connect the subscribing user with detailed information about each beneficiary recipient.

7. A method for associating subscribing users with multiple beneficiary recipients, the method comprising:
registering an affiliate organization by an authorized representative of the affiliate organization through an interface provided by a distributed network transactions processing system;
selecting by the authorized representative recipients to be associated with by the distributed network transactions processing system interface, wherein the distributed network accounting system provides code that the affiliate organization can embed in the user interface of the affiliate organization;
receiving by the distributed network transactions processing system input from a subscribing user that is accessing the user interface of the affiliate organization through the embedded code;
recording the association between the subscribing user and the beneficiary organization by the distributed network transactions processing system upon receiving input that a subscribing user is adding a beneficiary recipient that the affiliated organization displays to the user;
upon receiving input that a subscribing user is donating funds to a beneficiary user that the affiliated organization displays to the user, the method comprises:
communicating to the subscribing user by the distributed network transactions processing system the financial institutions that the subscribing user has registered with the distributed network transactions processing system;
connecting the subscribing user with a financial institution that the subscribing user selects so that the subscribing user can initiate a transfer of funds from the financial institution to the distributed network transactions processing system; and
transferring the funds from the distributed network transaction processing system to the one or more beneficiary recipient selected by the subscribing user; and
transferring by the distributed network transaction processing system a portion of the funds to the affiliate organization upon transferring funds to the beneficiary recipient.

8. The method of claim 7, further comprising transferring to the distributed network transaction processing system a portion of each purchase as stored funds belonging to the subscribing user that the subscribing user can later donate to beneficiary recipients.

9. The method of claim 7, wherein the affiliate organization is an aggregator of beneficiary recipients, the method further comprising:
selecting beneficiary recipients by the subscribing users through a user interface;
transmitting the selections to the distributed network transaction processing system; and
recording by the distributed network transaction processing system an association between the subscribing user and the selected beneficiary recipients.

10. The method of claim 7, wherein the affiliate organization is also a beneficiary recipient, the method further comprising:
donating funds by the subscribing user to the beneficiary recipient by distributing funds from the distributed network transaction processing system to the beneficiary recipient;
recording by the distributed network transaction processing system an association with the beneficiary recipient and the subscribing user.

11. The method of claim 7, providing code to the affiliate organization by the distributed network transaction processing system, wherein the code embedded in the affiliate organization user interface provides buttons that enable the subscribing user to transmit to a social networking systems information about the donation activity of the subscribing user.

12. A distributed network transaction processing system for associating subscribing users with multiple beneficiary recipients, the system comprising:
a basket services server to receive communications from affiliate organizations over a distributed network, communicate with the distributed network transaction processing system, and transmit responses to the affiliate organizations;
an affiliate authentication server coupled to the basket services server, the affiliate authentication server to authenticate the identity the affiliate organizations that are sending requests to the basket services server, and to transmit authentication information to the basket services server;
an organization database server coupled to the basket services server, the organization database server to store information about beneficiary recipients, conduct searches within the data for one or more beneficiary recipients, and transmit information about one or more beneficiary recipients to the basket server, for transmitting to an affiliate organization;
a user registration server coupled to the basket services server, the user registration server to store information about subscribing users, including a unique identifier for each subscribing user; and
a database management server coupled to the basket services server, the database management server to manage the forming of associations between subscribing users and beneficiary organizations, find subscribing users in the user registration server, find beneficiary organizations in an organization database, and present any associated information for each to the basket services server.

13. The distributed network transaction processing system of claim 12, further comprising a storage coupled to the database management server to store information about subscribing users, the beneficiary recipients the subscribing user has chosen to be associated with, and financial institutions the subscribing user has select as sources for funding.

14. The distributed network transaction processing system of claim 13, wherein the information stored in the data storage comprises which beneficiary recipients the subscribing user has selected to be associated with and financial institutions the subscribing user has selected as sources of funding.

15. The distributed network transaction processing system of claim 12, further comprising:
a display coupled to the a display coupled to the basket services server; and
a basket interface component coupled to the basket services server to display the beneficiary recipients a subscribing user has selected to the subscribing user.

16. The distributed network transaction processing system of claim 12, further comprising a user interface for the affiliate organizations.

17. The distributed network transaction processing system of claim 16, wherein the user interface for the affiliate organizations can be selected from the group consisting of websites on the World Wide Web, and communications to the distributed network system occur over the Internet.

18. The distributed network transaction processing system of claim 12, further comprising a display, wherein the distributed network transaction processing system associates beneficiary recipients with one or more categories, and displays those categories to the subscribing user through the basket component interface on the display.

19. The distributed network transaction processing system of claim 12, where the distributed network transaction processing system receives through the basket interface component input indicating that the subscribing user wishes to get more information about the contents of the basket, where the distributed network accounting system responds by transmitting information to the basket interface component to update the display with information about each beneficiary recipient associated with the subscribing user, including information that will connect the subscribing user with detailed information about each beneficiary recipient.

20. The distributed network transaction processing system of claim 12, wherein the distributed network truncation processing systems stores in the data store the regulatory, accounting, tax treatment of each beneficiary recipient.
